(19) United States
(12) Patent Application Publication
(10) Pub. No.: US 2024/0096016 A1
(43) Pub. Date: Mar. 21, 2024

(54) System And Method For Virtual Object Asset Generation

(71) Applicant: Wild Capture, Inc., Playa del Rey, CA (US)

(72) Inventors: Wilfred C. Driscoll, III, Playa del Rey, CA (US); Louis James-Karel Normandin, Los Angeles, CA (US)

(21) Appl. No.: 18/365,032

(22) Filed: Aug. 3, 2023

Related U.S. Application Data
(60) Provisional application No. 63/407,262, filed on Sep. 16, 2022.

(51) Int. Cl. G06T 17/10; G06T 15/04; G06T 17/20

(52) U.S. Cl. CPC G06T 17/10; G06T 15/04; G06T 17/205

(57) ABSTRACT

A system for virtual object asset generation and methods for making and using same. The system can create 3D surface models of objects in video space that provide a dynamic, frame and subframe solve of the models for object generation in streaming video. Advantageously, the system can yield more accurate results by providing more granular frame sequencing for generated virtual object assets. The system can utilize poses and derivation of location for a number of computer-generated virtual cameras to remove any need for additional data capture from physical cameras. The system can utilize a detailed muscle segmentation process, layered on top of a universal solve process, to create optimized realistic movement of the virtual objects in space and time that have a more realistic interaction with liquids and liquid objects in that space. The system likewise can permit additional layered effects to be applied over a created digital object.

### CROSS-REFERENCE TO RELATED APPLICATIONS

This application claims the benefit of, and priority to, U.S. Provisional Application Ser. No. 63/407,262, filed on Sep. 16, 2022, the disclosure of which is hereby incorporated herein by reference in its entirety and for all purposes.

### FIELD

The disclosed embodiments relate generally to systems for rendering three-dimensional characters and more particularly, but not exclusively, to systems and methods suitable for providing a voxel volume-based universal solve.

### BACKGROUND

Currently, three-dimensional (or 3D) character rendering is performed through the application of volumetric video input. This input data contains noise and anomalies, requires large file sizes and yields less accurate results. The input data also must be processed so as to attempt to avoid the consequences of the artifacts in the data. Existing 3D solve processes create models that do not yield realistic interaction with some types of objects within 3D model environments.

Unlike prior methods which rely primarily on optical input, the inventive process described herein relies on spatial data and real-time velocity of motion to generate superior renderings of 3D characters with improved fidelity, as well as generating far more realistic interactions of characters with objects with much greater efficiency. In addition, the process does not rely upon traditional triangular mesh quantization but rather uses spatial point data to create a quadrangular mesh capture mechanism offering higher spatial resolution approximating closer to immersion in virtual reality.

The process of three-dimensional character rendering may begin with a series of individual mesh files that make up one or more sequences of character positioning or movements in object (or OBJ) or three-dimensional polygon (or PLY 3D) mesh representations. These sequences come in the form of individual files with which a frame padding identifier helps to identify the frame sequence for the mesh file. In this instance, a 000001 may represent a frame padding of five.

An alternative is to use an alembic single file, which is a sequence of mesh files compiled into an alembic-formatted single file.

Each mesh has a coincident texture file, in which Joint Photographic Experts Group (or JPEG) or Portable Network Graphics (or PNG) are the most common formats for this texture file. The coincident texture file is typically run at thirty frames-per-second (fps) or sixty fps. Individually, this content has no connection from frame to frame. Each frame is commonly fresh data with no correlation to the frame before it or after it, although some content systems may have temporal coherence, which traditionally provides partial uniformity for up to twelve consecutive frames. No current solution described above universally works across all volumetric data platforms. Furthermore, each conventional system for solving volumetric video (or image) frames to create characters and objects is customized and inconsistent with other systems for solving volumetric image frames.

Existing systems for solving for character rendering and interaction in a 3D space frequently solve a two-dimensional (or 2D) representation first utilizing the input mesh (or topology) files and coincident texture files, then progress to a 3D reconstruction. This process is less than optimal for computer generated dynamic interaction because mesh topology artifacts, bumps and inconsistencies create a far less accurate rendition which does not provide the necessary realism in characters sought by VV developers. In addition, the existing inferior processes also result in an unnecessarily large file sizes, further inhibiting more widespread adoption of this technology into production processes.

In view of the foregoing, a need exists for a virtual object asset generation system and method for creating 3D surface models of virtual objects in video space that overcome the aforementioned obstacles and deficiencies of currently-available character rendering systems.

### BRIEF DESCRIPTION OF THE DRAWINGS

FIG. 1A is a detail drawing illustrating an exemplary embodiment of a virtual object.

FIG. 1B is a detail drawing illustrating an exemplary embodiment of a wireframe representation of the virtual object of FIG. 1A.

FIG. 2A is a high-level block diagram illustrating an exemplary embodiment of a virtual object asset generation system for creating one or more 3D surface models of the virtual object of FIG. 1A, wherein the virtual object asset generation system can communicate with one or more external imaging systems.

FIG. 2B is a high-level block diagram illustrating an alternative exemplary embodiment of the virtual object asset generation system of FIG. 2A, wherein the external imaging systems includes at least one camera system.

FIG. 2C is a detail drawing illustrating an exemplary embodiment of the camera system of FIG. 2B, wherein the camera system can be configured for capturing one or more image frames that show a positioning and/or movement of a physical object.

FIG. 3 is a high-level flow chart illustrating an exemplary embodiment of a virtual object asset generation method for creating one or more 3D surface models of the virtual object of FIG. 1A.

FIG. 4A is a high-level flow chart illustrating an exemplary embodiment of generating boundaries of movement for the virtual object via the virtual object asset generation method of FIG. 3.

FIG. 4B is a detail drawing illustrating an exemplary embodiment of a bounding box for defining a boundary of movement for the virtual object of FIG. 1A.

FIG. 4C is a detail drawing illustrating an alternative exemplary embodiment of the bounding box of FIG. 4B, wherein the virtual object is shown as traversing the bounding box.

FIG. 4D is a detail drawing illustrating still another alternative exemplary embodiment of the bounding box of FIG. 4B, wherein a negative space for the virtual object is shown within the bounding box.

FIG. 5 is a high-level flow chart illustrating an alternative exemplary embodiment of the virtual object asset generation method of FIG. 3, wherein the virtual object asset generation method includes creating a quadrangular mesh for the virtual object.

FIG. 6A is a high-level flow chart illustrating another alternative exemplary embodiment of the virtual object asset generation method of FIG. 3, wherein the virtual object asset generation method includes generating skeleton or other internal structural data for the virtual object.

FIG. 6B is a detail drawing illustrating an exemplary embodiment of a virtual camera system that replicates the camera system of FIG. 2.

FIG. 6C is a detail drawing illustrating an exemplary alternative embodiment of the virtual object of FIG. 1A, wherein the virtual object comprises a bipedal virtual character.

FIG. 6D is a detail drawing illustrating an exemplary embodiment of internal structural data for an internal structure of the bipedal virtual character of FIG. 6C.

FIG. 6E is a detail drawing illustrating an exemplary embodiment of the internal structural data for the internal structure of the bipedal virtual character of FIG. 6D, wherein the internal structural data can provide unsorted character data for the bipedal virtual character and a velocity grid per image frame of a grouping of image frames based upon a consistency and/or inconsistency of the internal structural data for the bipedal virtual character.

FIG. 6F is a detail drawing illustrating an exemplary embodiment of a uniform mesh created for the bipedal virtual character of FIG. 6C.

FIG. 7 is a detail drawing illustrating an exemplary embodiment of the grouping of image frames of FIG. 6E.

FIG. 8 is a detail process workflow diagram for the virtual object asset generation method of FIG. 3, wherein the virtual object asset generation method is configured for receiving triangular mesh data.

FIG. 9 is a detail drawing illustrating an exemplary embodiment of a triangular polygonal surface mesh sequence for input into the virtual object asset generation method of FIG. 3.

FIG. 10 is a detail drawing illustrating an exemplary embodiment of a wireframe mesh sequence for the triangular polygonal surface mesh sequence of FIG. 9.

FIG. 11 is a detail drawing illustrating an exemplary embodiment of an input polygonal surface mesh sequence for the triangular polygonal surface mesh sequence of FIG. 9.

FIG. 12 is a detail drawing illustrating an exemplary embodiment of UV coordinates image of a set of 2D float vector vertex attributes for the triangular polygonal surface mesh sequence of FIG. 9.

FIG. 13 is a detail drawing illustrating an exemplary embodiment of an input polygonal surface mesh animated sequence with mapped UV attributes for the triangular polygonal surface mesh sequence of FIG. 9.

FIG. 14 is a detail drawing illustrating an exemplary embodiment of a calibration data set for the virtual camera system of FIG. 6B.

FIG. 15 is a detail drawing illustrating an exemplary embodiment of an output biped skeleton.

FIG. 16 is a detail drawing illustrating an exemplary embodiment of a plurality of frame time values in a geometry sequence, wherein the frame time values have been merged together.

FIG. 17 is a detail drawing illustrating an exemplary embodiment of a sample of a volume from the merged frame time values of FIG. 16.

FIG. 18 is a detail drawing illustrating an exemplary embodiment of a voxel grid for showing occupied space of the merged frame time values of FIG. 16.

FIG. 19 is a detail drawing illustrating an exemplary embodiment of a single frame volume cloud density attribute for the triangular polygonal surface mesh sequence of FIG. 9.

FIG. 20 is a detail drawing illustrating an exemplary embodiment of a single frame volume cloud velocity attribute in a dense volume for the triangular polygonal surface mesh sequence of FIG. 9.

FIG. 21 is a detail drawing illustrating an exemplary embodiment of a single frame voxel velocity sample for the triangular polygonal surface mesh sequence of FIG. 9.

FIG. 22 is a detail drawing illustrating an exemplary embodiment of a voxel velocity sequence for the calibration data set of FIG. 14.

FIG. 23 is a detail drawing illustrating an exemplary embodiment of a quadrangular mesh generated for the triangular polygonal surface mesh sequence of FIG. 9.

FIG. 24 is a detail drawing illustrating an exemplary embodiment of a UV layout of a created uniform set for the generated quadrangular mesh of FIG. 23.

FIG. 25 is a detail drawing illustrating an exemplary embodiment of a voxel velocity grid and a negated volume region for the quadrangular mesh of FIG. 24.

FIG. 26 is a detail drawing illustrating an exemplary embodiment of a 3D mesh based upon the quadrangular mesh of FIG. 24.

FIG. 27 is a detail drawing illustrating an exemplary embodiment of a surface of mesh point normal pointing outward from an object.

FIG. 28 is a detail drawing illustrating an exemplary embodiment of a set of unique point numbers corresponding to a UV layout.

FIG. 29 is a detail drawing illustrating an exemplary embodiment of a backward distance velocity being inverted for predicting a deformation.

It should be noted that the figures are not drawn to scale and that elements of similar structures or functions may be generally represented by like reference numerals for illustrative purposes throughout the figures. It also should be noted that the figures are only intended to facilitate the description of the preferred embodiments. The figures do not illustrate every aspect of the described embodiments and do not limit the scope of the present disclosure.

### DETAILED DESCRIPTION OF THE PREFERRED EMBODIMENTS

Since currently-available three-dimensional (or 3D) character rendering systems and methods utilize input data with noise and anomalies, require large file sizes, yield less accurate results and create models that have no realistic interaction with some types of objects within 3D model environments, a virtual object asset generation system and method for creating 3D surface models of objects in video space that provide a dynamic, frame and subframe solve of the 3D models for object generation in streaming video can prove desirable and provide a basis for a wide range of applications, such as creating optimized realistic movement of objects in space that have a more realistic interaction with liquids, solids and/or gasses and/or liquid, solid and/or gaseous objects in the space. This result can be achieved, according to one embodiment disclosed herein, by a virtual object asset generation method 100 for creating 3D surface models of virtual objects 10 in video space.

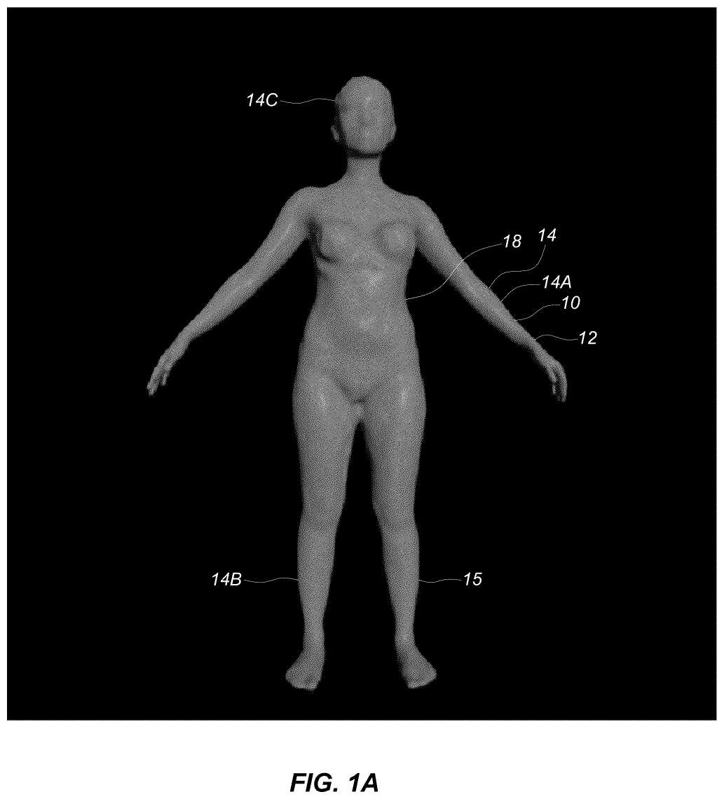

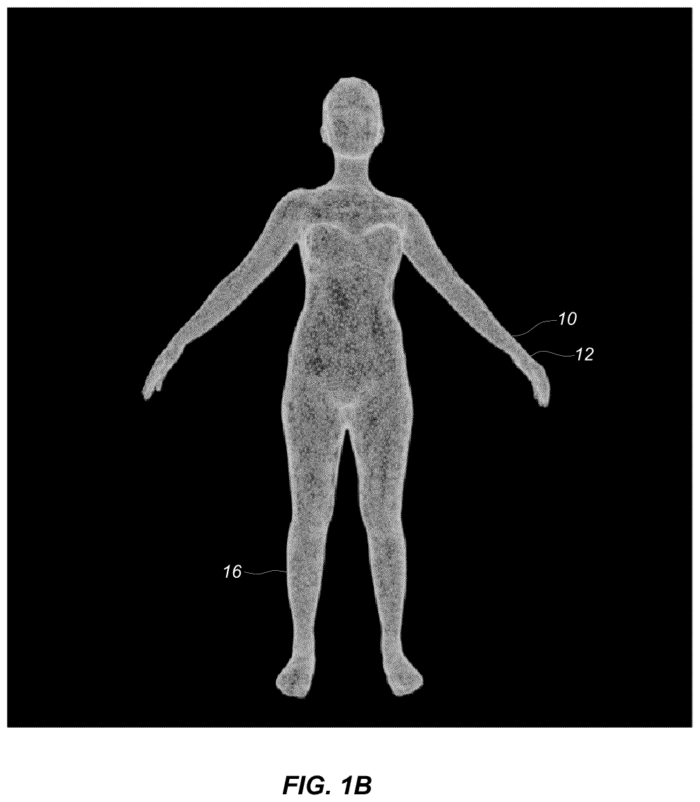

An exemplary virtual object 10 is illustrated in FIG. 1A. Turning to FIG. 1A, the virtual object 10 is shown as including an outer surface (or skin) 12, which can enclose or otherwise cover a skeleton or other internal structure (not shown) of the virtual object 10. The internal structure and/or the outer surface 12 of the virtual object 10 can deform as the virtual object 10 moves. In selected embodiments, the virtual object 10 can include one or more movable object members 14. The movable object members 14, for example, can be associated with a central (or main) object member 18. The movable object members 14 can be disposed in any predetermined arrangement relative to the central object member 18 and/or can be configured to move relative to the central object member 18. Additionally and/or alternatively, a first movable object member 14 of the virtual object 10 can be movable relative to a second movable object member 14 of the virtual object 10.

If the virtual object 10 comprises a virtual character, for instance, the movable object members 14 can comprise an arm 14A, a leg 14B and/or a head 14C, as shown in FIG. 1A. The outer surface 12 can deform to accommodate a motion of the movable object members 14 as the virtual character walks or otherwise moves. The deformation of the outer surface 12 can include not only deformations associated with physical movement of the movable object members 14, but also deformations associated with one or more bones, joints, muscles and other internal structures beneath the outer surface 12 and/or one or more external factors outside of the outer surface 12. Exemplary external factors can include, but are not limited to, wind, rain, water or other weather-related external factors and/or clothing or other external factors disposed on or otherwise associated with the virtual object 10. Although shown and described with reference to FIG. 1A as comprising a virtual character for purposes of illustration only, the virtual object 10 can comprise any suitable virtual object of any kind.

The virtual object asset generation method 100 advantageously can comprise a computer or other processor implemented method and/or can create one or more 3D surface models for modelling such deformations of the internal structure and/or the outer surface 12 of the virtual object 10. In selected embodiments, the virtual object asset generation method 100 can comprise an improvement to conventional conformity processes for creating virtual objects 10. The virtual object asset generation method 100 can conform a previously-recorded unsorted dataset of object performance data to provide functionality and simulate real world physics in action and movement of the virtual objects 10 created via use of computerized video processing of video (or image) input data.

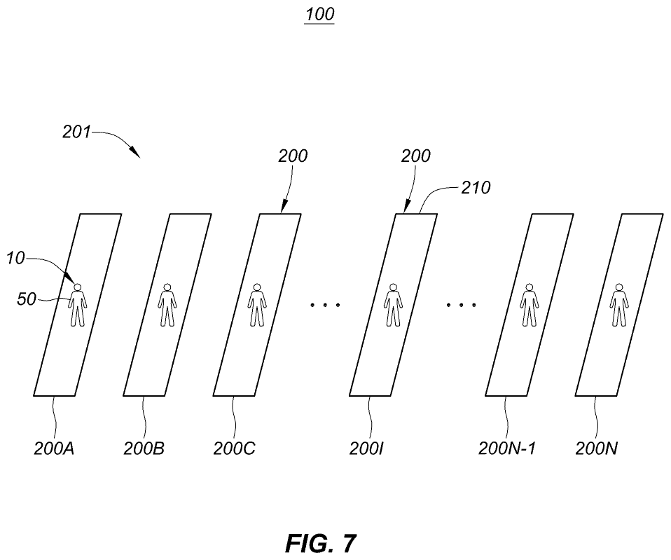

In selected embodiments, the object performance data can comprise a linear sequence or other grouping 201 of video (or image) frames 200 as shown in FIG. 7. Exemplary linear sequences can include, but are not limited to, image frames 200 that are arranged pursuant to one or more time stamps associated with the image frames 200 and/or a temporal arrangement of the image frames 200. Turning to FIG. 7, the grouping 201 of the image frames 200 is illustrated as including a predetermined number N of image frames 200 that depict respective aspects or other positioning of a physical object 50 associated with the virtual object 10. In other words, the image frames 200 can comprise images of the physical object as captured from a one or more different angles and/or in one or more different positions. The image frames 200 are shown as comprising a sequence beginning at a first image frame 200A The sequence of the image frames 200 can proceed to a second image frame 200B, to a third image frame 200C and so on until the Nth image frame 200N is reached.

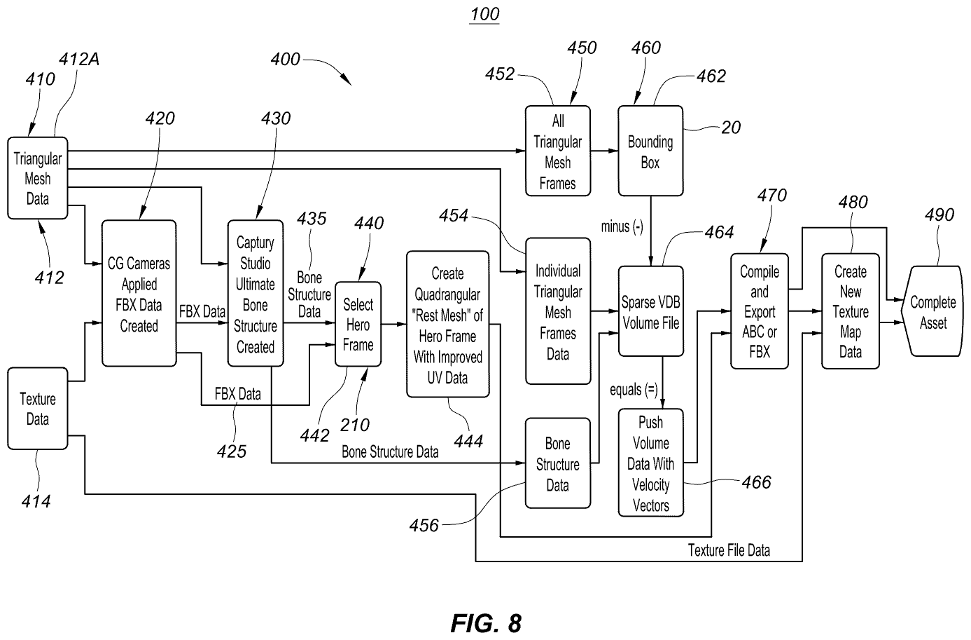

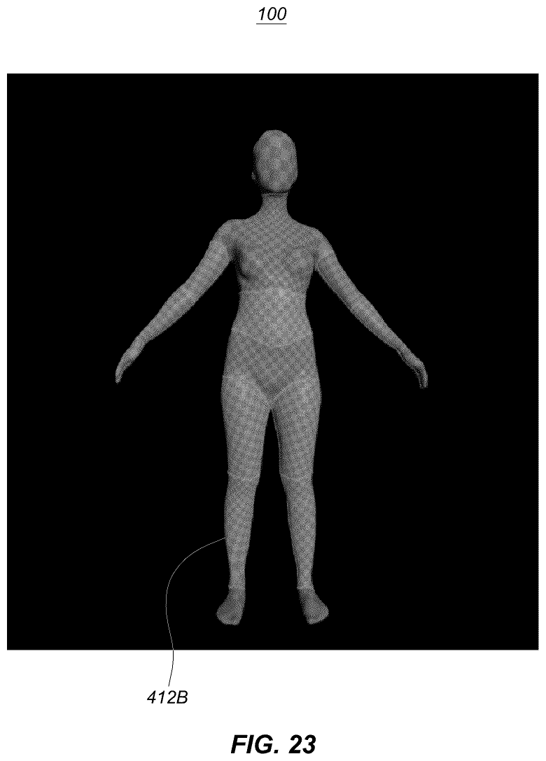

The virtual object asset generation method 100 as shown and described herein can comprise an automated (or nearly automated) solution for sorting a set of (volumetric) input data 410 (shown in FIG. 8). The input data 410 preferably comprises any set of data that follows a standardized data format. Exemplary input data can include, but is not limited to, three-dimensional (or 3D) mesh data 412 (shown in FIG. 8), such as three-dimensional triangular mesh data 412A (shown in FIG. 8) and/or three-dimensional quadrangular mesh data 412B (shown in FIG. 23), and/or texture data 414 (shown in FIG. 8) associated with the previously-recorded object positioning and/or movement of the virtual object 10. The received mesh data 412 and/or the received texture data 414, for example, can be derived from a linear sequence or other grouping 201 of image frames 200. Exemplary linear sequences can include, but are not limited to, image frames 200 that are arranged pursuant to one or more time stamps associated with the image frames 200 and/or a temporal arrangement of the image frames 200. The grouping 201 of image frames 200 can comprise a sorted grouping of the image frames 200 and/or an unsorted grouping of the image frames 200.

The mesh data 412 associated with the virtual object 10 can be based upon a three-dimensional (or 3D) polygonal surface mesh formed on the outer surface 12 of the virtual object 10. An exemplary 3D polygonal surface mesh 15 formed on the outer surface 12 of the virtual object 10 is illustrated in FIG. 1A. Returning to FIG. 1A, the 3D polygonal surface mesh 15 can comprise a topological (or visual) representation of the virtual object 10 at any given time and can be defined by a plurality of points (or vertices) in a three-dimensional space and a plurality of (straight and/or curved) lines for connecting adjacent points. Stated somewhat differently, the 3D polygonal surface mesh 15 can comprise an interconnected series of points that form a plurality of polygons, such as triangles and/or quadrangles.

The 3D polygonal surface mesh 15 thereby can comprise a web of connections, wherein each point is connected to one or more other points, such as the nearest points. In selected embodiments, a selected polygon with a first shape or other geometry, such as a triangle, within the 3D polygonal surface mesh 15 can be converted to a second (or different) shape or other geometry, such as a quadrangle. The 3D polygonal surface mesh 15 advantageously can provide a basis for generating a wire-frame model 16 of the virtual object 10 as shown in FIG. 1B. The wire-frame model 16 advantageously can specify each edge of the virtual object 10 at which two mathematically-continuous smooth surfaces meet. The wire-frame model 16, for example, can provide a visual representation of the virtual object 10 as used in 3D computer graphics.

In selected embodiments, the virtual object asset generation method 100 can create highly-detailed results for streaming video character or other object generation and/or provide an ability to predict in-depth computer-generated (or CG) muscle definition to a skeletal (or structural) system of generated virtual objects 10. An illustrative example can be using volumetric video (or images) to create a unified boundary of a digital representation of a human form, not only in the currently-used form that essentially equates to volumetric video to a moving blob of water or hologram, but also in a cellular, three-dimensional (or 3D) model that naturally takes on an ability to precisely model layers around it.

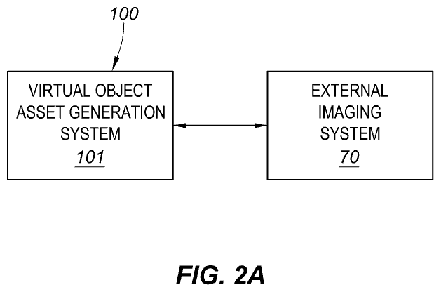

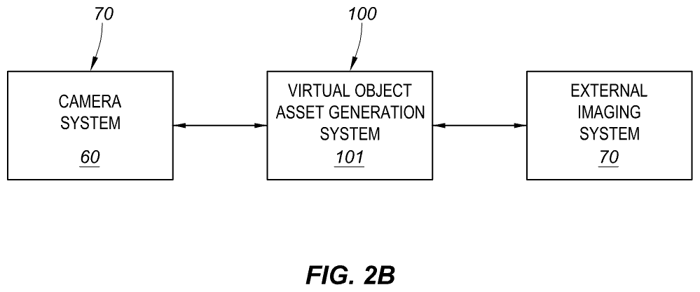

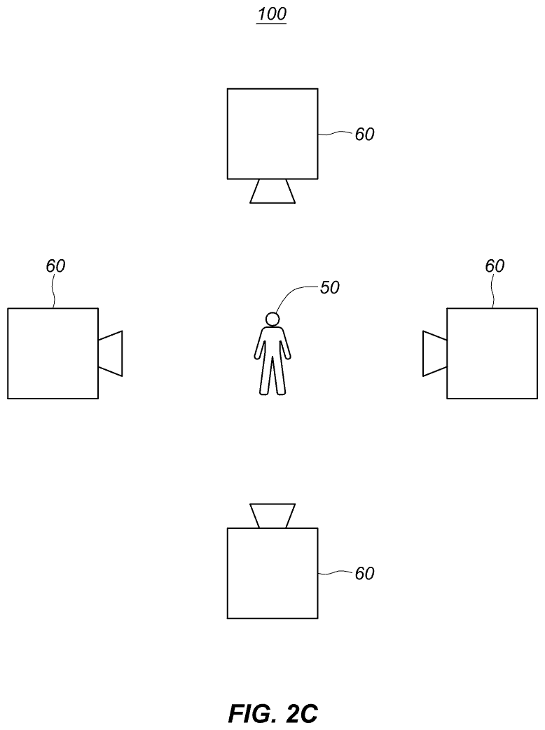

FIG. 2A shows an embodiment of a virtual object asset generation method 101 for creating 3D surface models of virtual objects 10 in video space. In selected embodiments, the virtual object asset generation system 101 can be configured to execute or otherwise perform the virtual object asset generation method 100. As shown in FIG. 2A, the virtual object asset generation system 101 can be configured to communicate with one or more external imaging systems (or circuits) 70. The virtual object asset generation system 101 and the external imaging systems 70 advantageous can cooperate for providing a complete virtual object asset.

The communication between the virtual object asset generation system 101 and each external imaging system 70 can be unidirectional and/or bidirectional. Depending upon a nature of a preselected external imaging system 70, the preselected external imaging system 70 can transmit or otherwise provide image data to the virtual object asset generation system 101, receive image data from the virtual object asset generation system 101, or both. The virtual object asset generation system 101 and the preselected external imaging system 70 can communicate directly and/or indirect via an intermediate system (or circuit), such as an interface system (not shown), without limitation.

Exemplary external imaging system 70 can include, but are not limited to, Captury, Captury Studio Ultimate, Quad Remesher available from Exoside via https://exoside.com/quadremesher/, and/or VDB file volume database files in a VDB format available from Broadcom Inc., of San Jose, California.

In selected embodiments, the external imaging system 70 can include at least one camera system (or circuit) 60 as shown in FIG. 2B. The external imaging system 70, in other words, can include one or more physical camera systems 60. The camera system 60 of FIG. 2B is shown as being in unidirectional communication with the virtual object asset generation system 101. Thereby, the camera system 60 can provide image data to the virtual object asset generation system 101. The virtual object asset generation system 101 likewise can communicate with one or more other external imaging systems 70. In selected embodiments, the virtual object asset generation system 101 can be centrally disposed or otherwise implemented among the external imaging systems 70. The camera systems 60 and/or the other external imaging system 70 advantageously can capture the sequence or other grouping 201 of image frames 200 for providing the mesh data 412 (shown in FIG. 8) and/or texture data 414 (shown in FIG. 8) that can comprise the input data for the virtual object asset generation method 100.

Turning to FIG. 2C, the virtual object 10 (shown in FIG. 1A) can be based upon at least one physical object 50. The physical object 50 is illustrated as being positioned in front of the camera systems 60. Stated somewhat differently, the camera systems 60 can be disposed about the physical object 50. The camera systems 60 can comprise any predetermined number of camera systems suitable for capturing images of the physical object 50. The number of the camera systems 60 can be variable, depending, for example, on a type, size, dimension, shape and/or other characteristics of the physical object 50, and preferably is sufficient to achieve a 360-degree view of the physical object 50. In selected embodiments, the number of the camera systems 60 can provide a sufficient number of look angles for capturing a complete range of motion of the physical object 50.

The camera systems 60 can comprise any suitable type of camera systems for capturing images of the physical object 50. Although preferably distributed about the physical object 50 in a uniform manner, the camera systems 60 can be positioned at any suitable distances and/or angles relative to the physical object 50 for capturing the positioning and/or movement of the physical object 50. The camera systems 60 thereby can capture the sequence or other grouping 201 of image frames 200 for providing the mesh data 412 Band/or texture data 4148 that can comprise the input data for the virtual object asset generation method 100.

The virtual object asset generation method 100 advantageously can allow for volumetric video to create collision boundaries that allow lifelike interaction with liquids, such as water, among other such interactions. In selected embodiments, the mesh data 412 and/or texture data 414 can utilize voxel-based density to locate an object volume of the virtual object 10 in space and turn the object volume into a consistent collision object. Advantages of a voxel-based solution can include, but are not limited to, all properties of the virtual object 10 being calculated and/or manipulated through object calculations as opposed to importing motion capture basis data that does not permit the level of data manipulation provided by the calculation of all object properties of the virtual object 10 in the voxel-based solution.

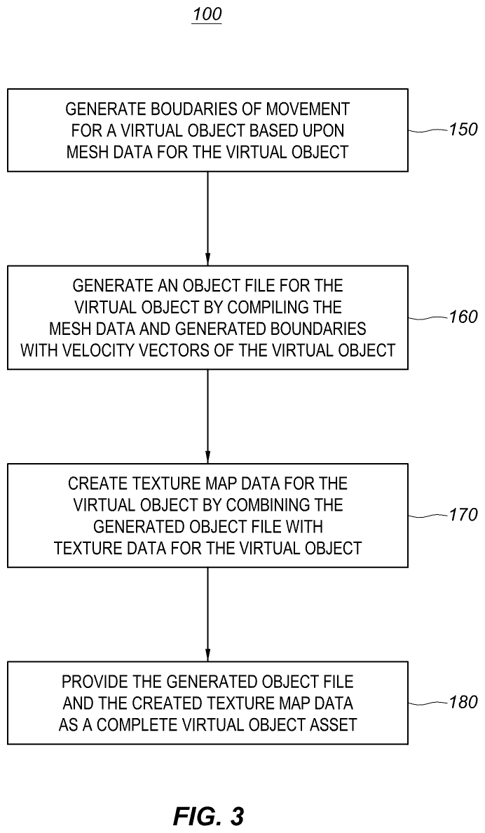

As illustrated in FIG. 3, for example, the virtual object asset generation method 100 can include, at 150, generating one or more boundaries of movement for the virtual object 10 (shown in FIG. 1A). The boundaries of movement can define a predetermined region within which the virtual object 10 can be permitted to move for creating the 3D surface models. In selected embodiments, the boundaries of movement for the virtual object 10 can be generated, at 150, based upon the mesh data 412 (shown in FIG. 8), such as the triangular mesh data 412A (shown in FIG. 8), for the virtual object 10. Stated somewhat differently, the virtual object asset generation method 100 can receive the mesh data 412 associated with the virtual object 10 and utilize the mesh data 412 to generate the boundaries of movement for the virtual object 10. The virtual object asset generation method 100 advantageously can receive the mesh data 412 associated with the virtual object 10 via optical systems (or circuits), such as the camera systems 60, and/or via non-optical systems (or circuits).

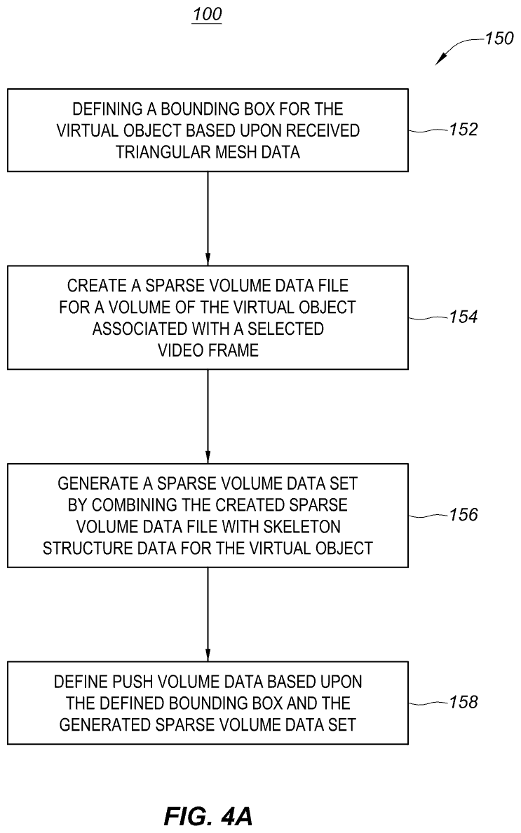

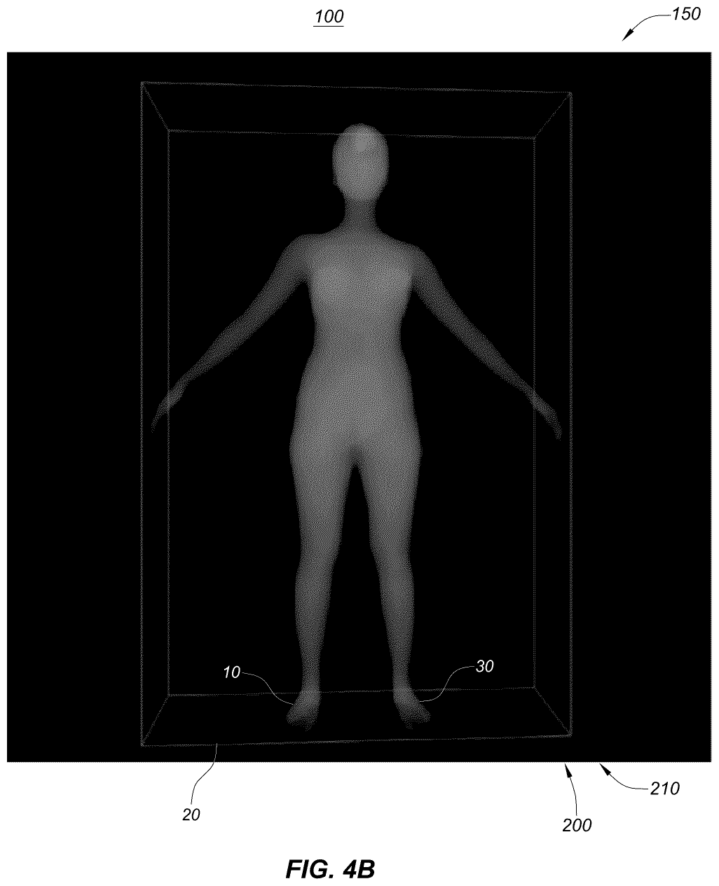

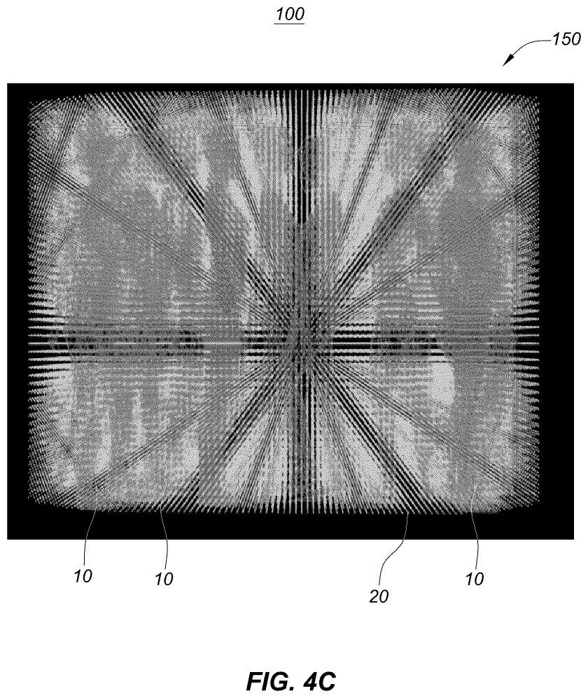

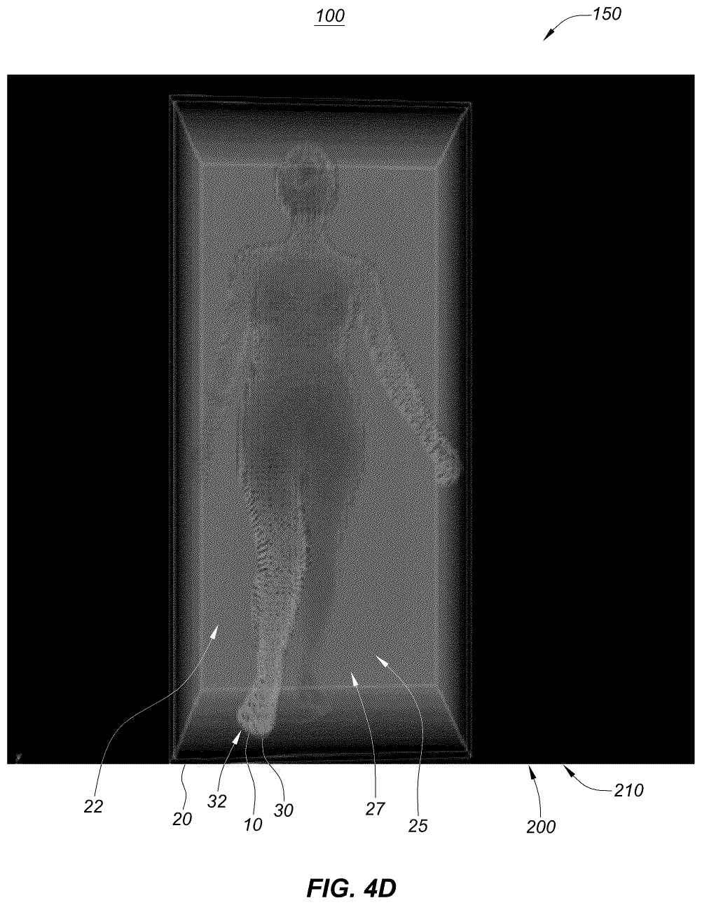

An exemplary manner for generating the one or more boundaries of movement for the virtual object 10, at 150, is shown in FIG. 4A. Turning to FIGS. 4A-D, the virtual object asset generation method 100 can include, at 152, defining a bounding box 20 for establishing the boundaries of movement for the virtual object 10. Stated somewhat differently, the bounding box 20 can represent outside bounds of movement for the virtual object 10. The virtual object asset generation method 100, for example, can utilize the mesh data 412 (shown in FIG. 8), such as the triangular mesh data 412A (shown in FIG. 8), from the image frames 200 included in the volumetric input data for defining the bounding box 20. As illustrated in FIG. 4C, the virtual object 10 is shown as traversing within the bounding box 20.

In selected embodiments, the bounding box 20 can be defined based upon the mesh data 412 associated with a selected (or hero) image frame 210 selected from among the image frames 200 included in the volumetric input data. Turning briefly to FIG. 7, the selected image frame 210 comprise any one of the image frames 200A-N in the grouping 201. The selected frame 210 is shown in FIG. 7, for example, as comprising the Ith image frame 2001 of the grouping 201.

Returning to FIG. 4C, the selected image frame 210 and the position of the physical object 50 within the selected image frame 210 can be selected to expose the camera systems 60 (shown in FIGS. 2B-C) to the selected image frame 210 and to determine a relative positioning for the camera systems 60 as a reference for the virtual object asset generation method 100. For example, the selected image frame 210 can comprise a “T frame” in the grouping 201 of image frames 200. A T frame can be one of the image frames 200 in which a bipedal character is positioned upright with upper limbs extended horizontally at a ninety degree angle (or perpendicularly) relative to a vertical main body of the character.

The virtual object asset generation method 100 can include, at 154, creating a sparse volume data file (not shown) for a volume of the virtual object 10 associated with the selected image frame 210. As shown in FIG. 4A, a (final) sparse volume data set 25 can be generated, at 156, by combining the created sparse volume data file with skeleton structural data 435 (shown in FIG. 8) for the virtual object 10. The sparse database volume file, for example, can be combined with skeleton, bone or other structural data for a skeleton (not shown) or other internal structure of the object 10 as set forth in the selected image frame 210 to generate the sparse volume data set 25. In selected embodiments, the sparse volume data set 25 can comprise a sparse VDB volume data set in the in VDB format. The sparse volume data set 25 for the virtual object 10 is shown as being disposed within the bounding box 20.

The virtual object asset generation method 100 can include defining push volume data based upon the defined bounding box 20 and the generated sparse volume data, at 158. In other words, the push volume data can comprise a difference between a bounding box volume 22 of the defined bounding box 20 and a sparse volume 27 associated with the sparse volume data set 25 as shown in FIG. 4D. The sparse volume data set 25, for example, can be subtracted from the defined bounding box 20 to create a negative space 30 representing an object volume 32 of the virtual object 10 within the bounding box 20. In other words, the virtual object asset generation method 100 can subtract the sparse volume 27 associated with the sparse volume data set 25 from the bounding box volume 22 of the defined bounding box 20 to determine the object volume 32 of the virtual object 10. In selected embodiments, the push volume data can be calculated based upon the negative space 30 and can include one or more velocity vectors for defining at least one limitation of motion for the virtual object 10.

The virtual object asset generation method 100 thereby can identify any consistencies in the mesh data 412 (shown in FIG. 8) from the image frames in the bounding box 20 as the virtual object 10 moves between positions. For example, the virtual object asset generation method 100 can identify any pieces of the virtual object 10 that may be left out of the bounding box 20 as the virtual object 10 translates between positions. The virtual object asset generation method 100 optionally can create a cast of the negative space 30 for the virtual object 10 within the bounding box 20 as defined by the mesh data 412 and the velocity vectors for the virtual object 10. The negative space 30, the velocity vectors for the virtual object 10, the sparse volume data set 25 and/or an orientation of the skeleton of the object 10 can be used to determine a spatial location and/or a direction of the virtual object 10.

In selected embodiments, the virtual object asset generation method 100 can control the deformation of the mesh data 412 to represent location from a first position to a second position. This deformation can be controlled, for example, by locating where the mesh data 412 is in the linear sequence of image frames 200 and/or where the mesh data 412 is with the pose estimation skeleton oriented as a centroid and up-vector position in the image frame 200.

An optional surface smoothing deformer (not shown) can be based upon a distance between two self-collisions of the virtual object 10 on a polygonal surface. In selected embodiments, the virtual object asset generation method 100 can create a repulsive relationship between the polygonal surfaces to allow the fabric associated with a surface of the virtual object 10 to slip between the positional surfaces of the two polygonal surfaces. This repulsive relationship advantageously can create a crease so that no clamping of the fabric occurs during motion of the virtual object 10. The quadrangular mesh changes, for example, can be driven through a quadrangular re-meshing algorithm that is driven through the volume velocity grid. Additional detail can be calculated via addition of calculated finger data for providing more accurate results for the precise movement of a virtual object 10 through space.

The virtual object asset generation method 100 advantageously can use the above referenced parameters as well as velocity data associated with the muscular features, such as biceps or other locations on a body of the virtual object 10, as a part of the solve. In an embodiment, the muscle data can be tied to the skeletal (or structural) system solved in the hero frame by assuming that muscles have attachment points to particular bones, and that muscles run along the same lines as the bones to which they are attached.

In a non-limiting example where the skeleton solve in the selected frame 210 is the skeletal system for a bipedal character, the virtual object asset generation method 100 may use the understanding of a bipedal skeleton movement to allow consistent points in space to transfer the velocity data, relative to the zero reference of the selected frame 210, as the points on a body having a bipedal skeleton change through a video (or image) sequence. A portion of the movement, velocity, and character positional change is driven by the interconnectivity of the bones of the skeletal system.

If the virtual object 10 comprises a character having a bipedal skeleton, for instance, there are locators consistently at the joint locations of the bone structure through the volumetric space. The locators may be used to average the velocity from the locators to the nearest point of the surface mesh of the bipedal character to derive the push volume. In this solution the hierarchy of the bones in the skeletal system, meaning how the bones are connected, what moves first and last and/or how the bones move relative to one another, can be identified through segmentation and used to derive an accurate set of movements of the skeletal system as a whole based upon what is possible for movement of a bipedal skeleton when connected at a particular set of joints and using a particular hierarchy of the bones within the skeletal system.

In another non-limiting example, if the bone data for the virtual object 10 in the selected frame 210 does not represent a bipedal character, a different set of joints and a different hierarchy for the segmentation of the bones and muscles may be used to provide consistent movement of the skeletal system and surface mesh for a non-bipedal character.

In each example, the push volume, that volume that is moved or repositioned as a result of movement of the virtual object 10, can be calculated from the joints of the bone structure itself regardless of the skeletal system configuration. This data also can translate similarly with the muscular structure that is connected to, and aligned with, the bones in the skeletal structure. The virtual object asset generation method 100 solve for the skeletal and muscle structure movement optionally can consider the physics of muscle flexion, bone deformation from impacts, and other considerations to maintain the accuracy of movement for the push volume that can be calculated for the entire sequence of movement.

The virtual object asset generation method 100 advantageously can utilize accurate velocity data for various portions of the virtual object 10 to provide a highly accurate volumetric surface identifying capabilities to allow a lifelike collision surface with all elements, such as liquids, solids, gases and particles. Additionally and/or alternatively, the virtual object asset generation method 100 can include an advanced solver solution (not shown) for performing solver calculations utilizing only velocity data from the virtual object 10 to be realized, calculating a delta of motion in the mesh data 412 associated with the virtual object 10 and moving the mesh data 412 from image frame 200 to image frame 200.

In selected embodiments, each velocity point can be approximated by combining individual rotational appendages, such as a knee, neck or other joint, to identify where portions of the virtual object 10 can move. The solver solution can be created to estimate generalities on positions of the joints of the virtual object 10. Advantageously, the solver solution can provide a more accurate version of the uniform solve. In the solver solution, two positions for the virtual object 10 can be generated from the data. The cage mesh and the volumetric video (or image) data then can be created without skeletal deformation. Using the accurate velocity data in the solution can mean that points representing portions of the virtual object 10 are not pushed past the limitations of the tracking volume, but the virtual object asset generation method 100 can use more tracking volume in space for the virtual object 10. Data can be generated that not only allows proving for the skeletal solve, but also allows for automated solves specific to muscle groups as an output of the segmented universal solver.

This solver solution within the virtual object asset generation method 100 optionally can provide a boundary that acts as a container having a surface collision boundary with other asset boundaries within the computer-generated world that simulates the laws of physics in the real world. The process modifies the boundary for things like fashion draping over the virtual object 10, logos and other computer-generated cloth, and/or special effects.

Volumetric data has no inherent velocity from which to perform calculations relative to a base or rest position. The virtual object asset generation method 100 advantageously can create a skeletal solution for bone data of an object. The skeletal solution advantageously can have velocity data in each image frame 200 as the skeleton is deformed through the image frames 200 of the grouping 201. To create this skeleton solution, the virtual object asset generation method 100 can consider and predetermine what image frame 200 may be considered as having zero velocity from which all other frame velocities can be calculated as interpolations and offsets from that zero velocity frame.

Combining the skeleton solution for the object in the predetermined image frame with the surface mesh solution for the object in the selected frame 210 can provide the zero or rest position for both the skeleton (bone data) and the surface mesh for the object in the grouping 201. Having a zero velocity, or rest, position for both the skeleton and surface of the object advantageously can permit accurate alignment of the mesh and bones to produce accurate alignment and animation of the object in the grouping 201. In a non-limiting example in which the object in the image frame is a character, the virtual object asset generation method 100 can utilize the selected frame 210 as a reference point from which the skeleton and surface of the character may be interpolated, deformed, re-aligned, moved, and/or otherwise manipulated for the image frames 200 in the grouping 201 that occur both before and after the selected frame 210.

Additionally and/or alternatively, the virtual object asset generation method 100 can identify any consistencies and/or any inconsistencies in the mesh data 412 as the virtual object 10 moves between positions. Identification of both consistencies and inconsistencies in the mesh data 412 advantageously can help increase the accuracy of predictions as the virtual object 10 translates between positions. Consideration of the inconsistencies can include determination of a level of inconsistency that can be tolerable with regard to psycho-visual accuracy of the virtual object 10 from a perspective of a user of the method 100. The degree of inconsistency, for example, can be established at a predetermined level of inconsistency, such as a resolution of the virtual object 10, that is consistent with conventional traditional image processing methodologies, without limitation.

Returning to FIG. 3, the virtual object asset generation method 100 can include, at 160, generating an object file (or an object data file) for the virtual object 10 (shown in FIG. 1A) by compiling the mesh data 412 and the generated boundaries with velocity vectors of the virtual object 10. The virtual object asset generation method 100, for example, can compile the three-dimensional triangular mesh data 412A (shown in FIG. 8) and/or the three-dimensional quadrangular mesh data 412B (shown in FIG. 23) with the generated boundaries and the associated velocity vectors of the virtual object 10 to generate the object data file for the virtual object 10.

In manner discussed herein, the three-dimensional quadrangular mesh data 412B can comprise three-dimensional quadrangular mesh data received by the virtual object asset generation method 100 and/or three-dimensional quadrangular mesh data that is derived from the three-dimensional triangular mesh data 412A received by the virtual object asset generation method 100. Exemplary formats for the object data file can include, but are not limited to, an alembic (or ABC) file format, a filmbox (or FBX) file format and/or a Glulx Blorb (GLB) file format. The GLB file format, for instance, can comprise a binary file format representation of a three-dimensional model that is saved in a GL Transmission format (or gITF).

The virtual object asset generation method 100, at 170, can include creating texture map data (or a texture map data file) for the virtual object 10 by combining the generated object data file with the texture data 414 (shown in FIG. 8) for the virtual object 10. The generated object data file for the virtual object 10 and the created texture map data optionally can be provided as a complete virtual object asset for the virtual object 10, at 180. In selected embodiments, the generated object data file and the created texture map data for the virtual object 10 can be combined to form the complete virtual object asset. Stated somewhat differently, the virtual object asset generation method 100 can output the completed character data file and the texture map data file as the complete virtual object asset. The virtual object asset generation method 100 can provide the complete virtual object asset in a suitable format that is compatible with one or more 3D video presentation systems (or circuits) (not shown).

In the manner discussed in more detail above with reference to the virtual object 10 shown in FIG. 1A, the virtual object 10 optionally can include one or more movable object members 14, such as an arm 14A, a leg 14B and/or a head 14C. In selected embodiments, the virtual object asset generation method 100 can support a replacement function for at least one movable object members 14 of the virtual object 10. A selected movable object member 14 of the virtual object 10, in other words, can be replaced by a different movable object member 14. If the virtual object 10 comprises a virtual character, for instance, the head 14C can be replaced with a different head to change the virtual object 10 from a first virtual character to a second virtual character, without limitation.

The virtual object asset generation method 100 can enable the replacement function via a linear analysis of the performance and/or movement of the virtual character and how to manipulate the virtual character against a predetermined character position, such as a character rest position. Stated somewhat differently, the virtual object asset generation method 100 can utilize the velocity vectors as a part of the linear analysis. The virtual object asset generation method 100, for example, can utilize the velocity vectors to predict a position of the virtual character 10 at a future time. In selected embodiments, the virtual object asset generation method 100 can predict the future position of the virtual object as a function of time can also be used independent of replacement.

Additionally and/or alternatively, the virtual object asset generation method 100 advantageously can utilize one or more points where muscle flexing within of the virtual character can be manipulated or otherwise used. Thereby, if a selected portion of the performance of a first virtual character comprises a series of calibration poses, the virtual object asset generation method 100 can replace the first virtual character with a second virtual character that performs the same series of calibration poses. The selected portion of the performance of the first virtual character can comprise an initial portion, middle portion and/or end portion of the performance of the first virtual character.

In selected embodiments, the virtual object asset generation method 100 can change (or blend) the faces of the first and second virtual characters to help enable a blending multiple takes of the same movements and/or performance. The virtual object asset generation method 100 optionally can employ artificial intelligence to blend real-world dialogue with the virtual character such that the interaction seems natural to a human user of the virtual object asset generation method 100. Additionally and/or alternatively, high speeds, high frame recording rates and other high frequency detail in the image frames 200 (shown in FIG. 4B) and other results can enable the virtual object asset generation method 100 to calculate muscular data by comparing a difference between a first pose of the virtual character as shown in the first image frame 200A (shown in FIG. 7) and a second pose of the virtual character as shown in the second image frame 200B (shown in FIG. 7).

For example, the virtual object asset generation method 100 can compare a rest pose of the virtual character with no flexion as shown in the selected (or hero) image frame 210 (shown in FIG. 4B), and a flexion pose of the virtual character as shown in the second image frame 200 to calculate the muscular data. The virtual object asset generation method 100 can compare the calculated muscular data with a current state of flexion of the virtual character for any given image frame 200 among the linear sequence or other grouping 201 of image frames 200. Thereby, the virtual object asset generation method 100 advantageously can enable the muscular data to be created and used independently of, and/or in congruence with, other data sets associated with the virtual character.

In the manner discussed in more detail above with reference to FIG. 1, the mesh data 412 (shown in FIG. 8) received as the input data by the virtual object asset generation method 100 can comprise three-dimensional triangular mesh data 412A (shown in FIG. 8). In selected embodiments, the virtual object asset generation method 100 advantageously can convert the three-dimensional triangular mesh data 412A into three-dimensional quadrangular mesh data 412B (shown in FIG. 23), which can help enhance a quality of the complete virtual object asset for the virtual object 10 provided by the virtual object asset generation method 100, at 180 (shown in FIG. 3). The three-dimensional quadrangular mesh data 412B, for example, can provide higher quality animation of deformations of the outer surface 12 (shown in FIG. 1A) of the virtual object 10.

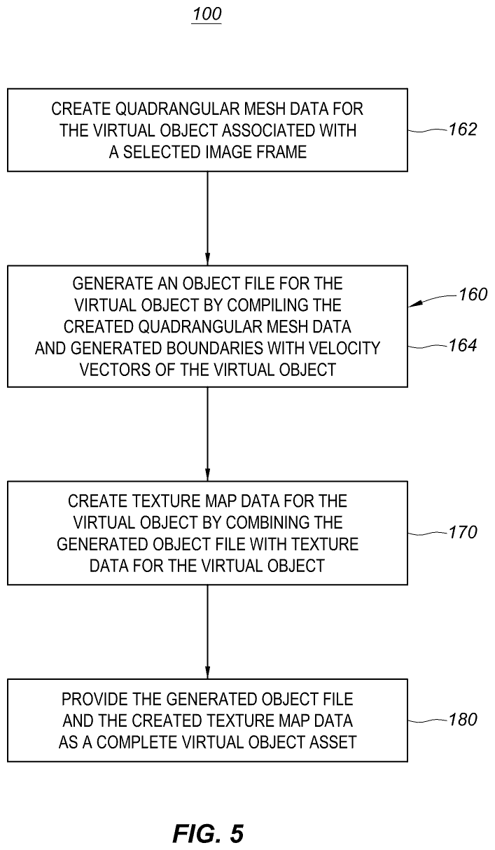

An exemplary embodiment of the virtual object asset generation method 100 in which the three-dimensional triangular mesh data 412A can be converted into three-dimensional quadrangular mesh data 412B is shown in FIG. 5. Turning to FIG. 5, the virtual object asset generation method 100 is illustrated as including, at 162, creating the three-dimensional quadrangular mesh data 412B (shown in FIG. 23) for the virtual object 10 associated with the selected (or hero) image frame 210 (shown in FIG. 4B). The virtual object asset generation method 100 can select the selected image frame 210 from among the image frames 200 included in the volumetric input data in the manner set forth above with reference to FIGS. 4A-D.

The virtual object asset generation method 100 can utilize the object data file for the virtual object 10 as positioned in the selected image frame 210 to convert the three-dimensional triangular mesh data 412A into the three-dimensional quadrangular mesh data 412B. In selected embodiments, the three-dimensional triangular mesh data 412A can comprise a quadrangular rest mesh for the outer surface 12 (shown in FIG. 1A) of the virtual object 10. The three-dimensional quadrangular mesh data 412B can be created in any suitable manner. An exemplary suitable manner can include, but is not limited to, use of licensed application software, such as Quad Remesher available from Exoside via https://exoside.com/quadremesher/ for creating the quadrangular mesh for the one or more virtual objects 10.

The created quadrangular rest mesh may be deformed linearly through time, forward and/or backward, producing a more-accurate and uniform surface solve for each virtual object 10. The virtual object asset generation method 100 thereby can create a collidable boundary for the outer surface 12 of the virtual object 10. The collidable boundary advantageously can use backward velocity that is deformed to at least one internal structure, such as a muscle group, of the object 10 that pushes the outer surface 12 of the virtual object 10 with subframe accuracy. The subframe accuracy of the outer surface 12 of the virtual object 10 optionally can be provided in an adjustable or otherwise quantifiable manner, as desired.

In selected embodiments, the object data file can be used as an input for informing a pose estimation process. The object data file, for example, can provide one or more input characteristics to permit a machine learning library to incorporate data for calculating the skeleton or other internal structure of the 3D model of the virtual object 10. The data for calculating the skeleton or other internal structure of the 3D model of the virtual object 10 can be provided via integration of a software application, such as Captury, without limitation.

Additionally and/or alternatively, the object data file can inform the selected (or hero) image frame 210. The selected image frame 210 optionally can be set as the rest position of the virtual object 10 for which a bone, skeleton or other internal structure calculation can be performed in the manner discussed above. When the machine learning library creates bone structure data, for example, the bone structure for the selected image frame 210 of the virtual object 10 can be created and combined with the data for the selected image frame 210. The machine learning library can update each of the image frames 200 (shown in FIG. 4B) in the linear sequence or other grouping 201 that show the virtual image 10 as being deformed with reference to the selected image frame 210. The updated image frames 200 can include image frames 200 that precede and/or succeed the selected image frame 210 in the grouping 201 of the updated image frames 200.

Referencing the selected image frame 210 as the rest position advantageously can permit forward and/or backward deformation of the bone structure data for each image frame 200 in the grouping 201 in accordance with how real bones could possibly move and can take into account the actual physics of movement in the creation of the deformation, again with reference to the rest position of the selected image frame 210. In selected embodiments, all translations of the bone structure data, in terms of position, movement, and/or deformation, may be based on the rest position of the bone structure data in the selected image frame 210 for an entire video (or image) sequence.

The virtual object asset generation method 100 of FIG. 5 can include, at 164, generating an object file (or an object data file) for the virtual object 10 by compiling the created three-dimensional quadrangular mesh data 412B and the generated boundaries with velocity vectors of the virtual object 10. In selected embodiments, the object file (or an object data file) for the virtual object 10 can be generated, at 164, in the same manner that the object file (or an object data file) for the virtual object 10 is described as being generated with reference to FIG. 3. The virtual object asset generation method 100, for example, can compile the three-dimensional quadrangular mesh data 412B with the generated boundaries and the associated velocity vectors of the virtual object 10 to generate the object data file for the virtual object 10.

The virtual object asset generation method 100, at 170, can include creating texture map data (or a texture map data file) for the virtual object 10 by combining the generated object data file with the texture data 414 (shown in FIG. 8) for the virtual object 10. The generated object data file for the virtual object 10 and the created texture map data optionally can be provided as a complete virtual object asset for the virtual object 10, at 180. In selected embodiments, the generated object data file and the created texture map data for the virtual object 10 can be combined to form the complete virtual object asset. Stated somewhat differently, the virtual object asset generation method 100 can output the completed character data file and the texture map data file as the complete virtual object asset. The virtual object asset generation method 100 can provide the complete virtual object asset in a suitable format that is compatible with one or more 3D video presentation systems (or circuits) (not shown).

The virtual object asset generation method 100 optionally can generate 3D volumetric video for supporting predictive clothing estimation, character lighting, eye tracking, re-projecting faces, performance blending, body replacement and/or head replacement for the virtual object 10 and/or the virtual object asset, without limitation. The body replacement feature and/or head replacement feature for the virtual object 10, for example, can comprise a linear analysis of performance and movement of the virtual object 10 and/or a manner for manipulating the virtual object 10 against a rest position.

Utilizing points where muscle flexing can be used and manipulated, a human character performance with a series of calibration poses at the beginning of the performance could be replaced with another person who performs the same calibration positions. The virtual object asset generation method 100 then can change (or blend) faces geared toward blending multiple takes of the same movements and performance.

Additionally and/or alternatively, the virtual object asset generation method 100 can employ artificial intelligence to blend real world dialogue with the virtual object 10 such that the interaction seems natural to a user (not shown) of the virtual object asset generation method 100.

The high frequency detail and results of the virtual object asset generation method 100 can generate data associated with one or more differences between a rest pose keyframe with no flexion and a flexion pose to calculate muscular data and compare the difference data with a current state of flexion for any given frame. The virtual object asset generation method 100 thereby can create muscular data and use the created muscular data independently or in congruence with the other data sets.

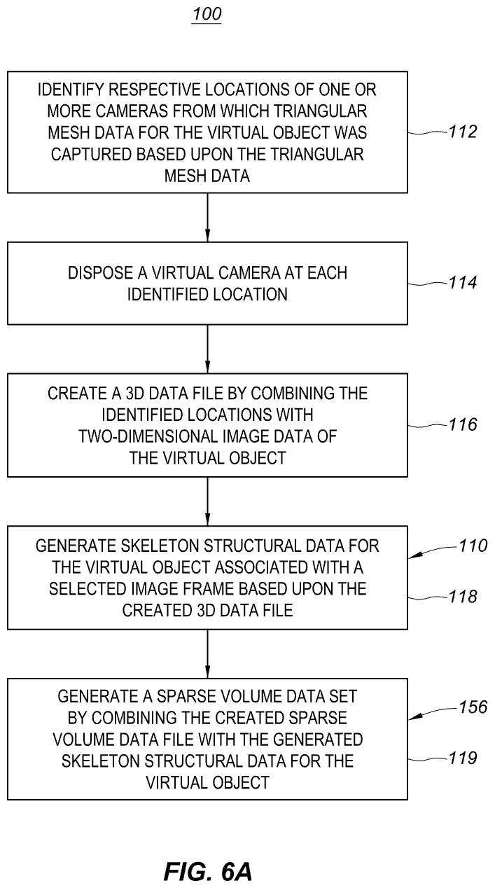

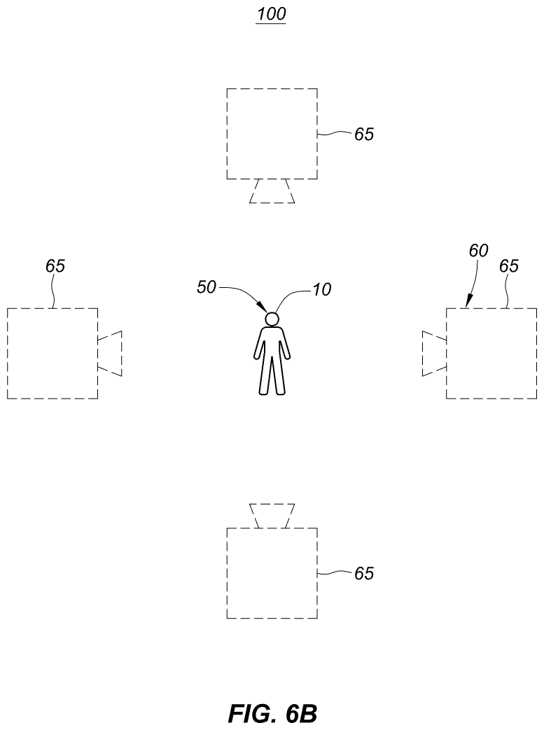

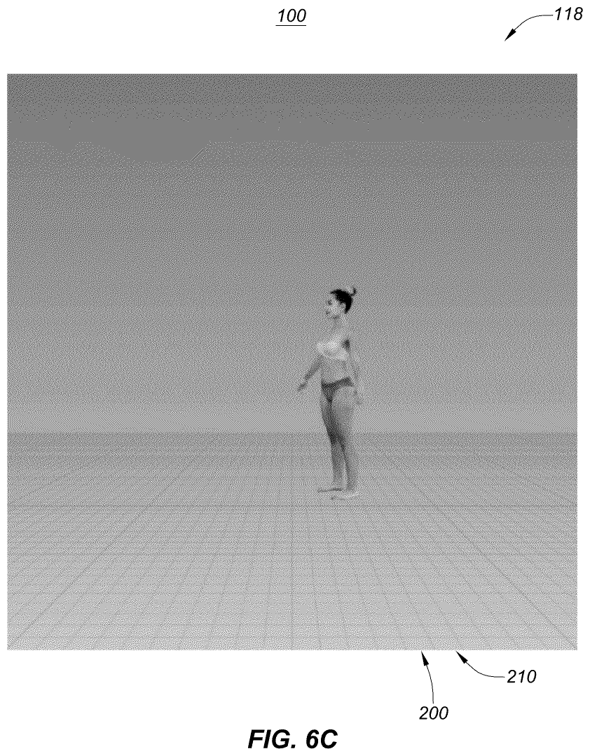

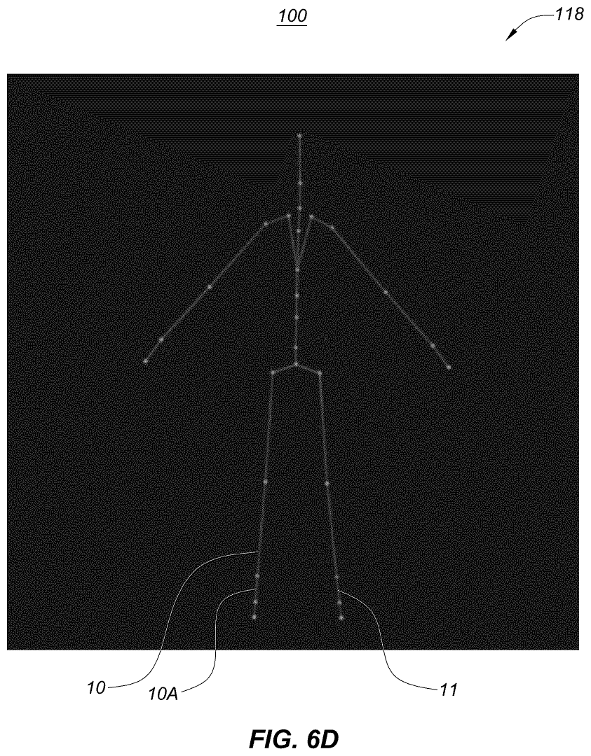

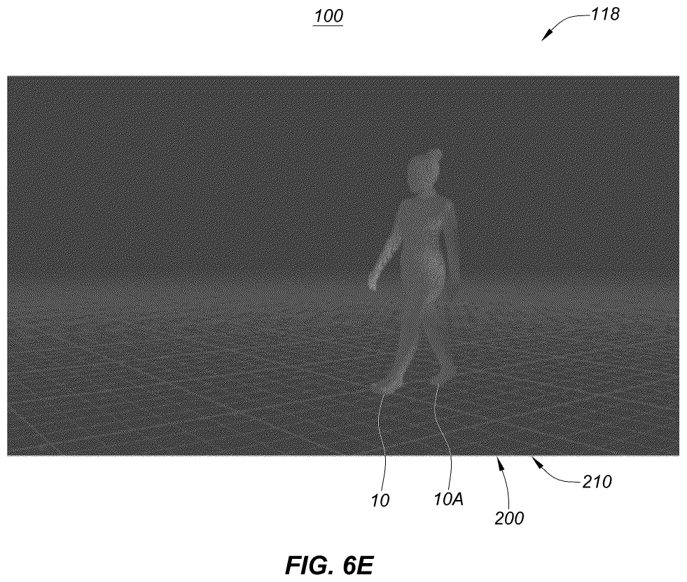

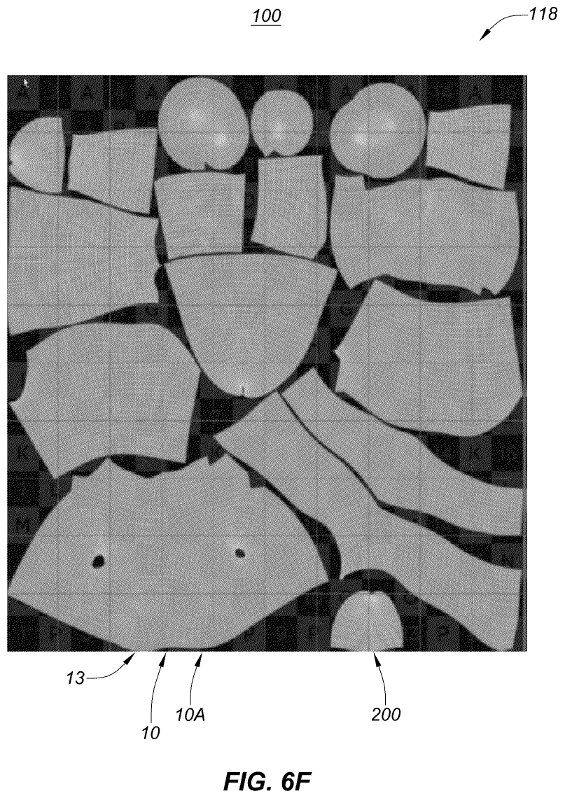

In selected embodiments, the virtual object asset generation method 100 can be configured to generate bone, skeleton or other internal structure data for the virtual object 10. An exemplary method 110 for generating the internal structure data for the virtual object 10 is illustrated in FIGS. 6A-F. Turning to FIG. 6A, the virtual object asset generation method 100 can include, at 112, identifying respective location information for one or more camera systems 60 (shown in FIGS. 2B-C) from which the mesh data 412 (shown in FIG. 8) for the virtual object 10 (shown in FIGS. 6C-D) was captured based upon the mesh data 412. Stated somewhat differently, the virtual object asset generation method 100 can utilize the mesh data 412 to identify prospective location information for the camera systems 60 that captured the mesh data 412. The mesh data 412 for identifying the respective location information for the camera systems 60 can comprise the three-dimensional triangular mesh data 412A (shown in FIG. 8) and/or the three-dimensional quadrangular mesh data 412B (shown in FIG. 23), without limitation.

The virtual object asset generation method 100, at 114, can dispose at least one virtual camera system 65 about the virtual object 10 at each of the respective location information associated with the camera systems 60 as shown in FIG. 6B. The virtual camera systems 65, in other words, can be disposed about the virtual object 10 in the same configuration as the camera systems 60 of FIGS. 2B-C were disposed about the physical object 50. The virtual camera systems 65 thereby can be positioned the same distances and/or angles relative to the virtual object 10 as distances and/or angles of the camera systems 60 relative to the physical object 50 when capturing the positioning and/or movement of the physical object 50. The virtual object 10 is illustrated as being positioned in front of the virtual camera systems 65. Although shown and described with reference to FIG. 6B as corresponding in number and configuration with the camera systems 60 of FIG. 2C for purposes of illustration only, the virtual camera system 65 can be disposed about the virtual object 10 in any suitable number and configuration. The virtual camera system 65, in other words, can comprise a number and configuration that is different from the number and configuration of camera systems 60 shown in FIG. 2C.

In selected embodiments, a first predetermined number of virtual camera systems 65 can be configured to perform as or otherwise replace a second predetermined number of camera systems 60. A single virtual camera system 65, for example, can be configured to perform as, or otherwise replace, one or more camera systems 60. Additionally and/or alternatively, a single camera system 60 can be configured to perform as, or otherwise replace, one or more virtual camera systems 65.

By identifying the respective location information for the camera systems 60 from which the mesh data 412 for the virtual object 10 was captured, the virtual object asset generation method 100 can recreate physical camera system values of the camera systems 60 with input volumetric video asset included in computer generated data to represent a real-world camera system calibration. Once calibrated, the virtual camera systems 65 can generate output data from each virtual camera system 65 that can be replicated via a selected 3D video processing application. The virtual object asset generation method 100 advantageously can utilize the virtual camera systems 65 as computer generated (or CG) cameras for further processing the mesh data 412, the texture data 414 (shown in FIG. 8) and/or the other volumetric input data.

Returning to FIG. 6A, the virtual object asset generation method 100 can create a 3D data file by combining the identified respective location information for the virtual camera systems 65 (shown in FIG. 6B) with two-dimensional image data of the virtual object 10, at 116. The two-dimensional image data of the virtual object 10, for example, can be virtually captured by, or otherwise associated with, the virtual camera systems 65. In selected embodiments, the two-dimensional image data of the virtual object 10 can include, but is not limited to, image data from the camera systems 60 (shown in FIGS. 2B-C). An exemplary format for the 3D data file can comprise a filmbox (or FBX) file format, without limitation.

The virtual object asset generation method 100, at 118, can include generating the skeleton, bone or other internal structural data 11 for a skeleton (not shown) or other internal structure of the virtual object 10 based upon the created 3D data file as shown in FIGS. 6C-D. If the mesh data 412 (shown in FIG. 8) and/or texture data 414 of the virtual object 10 is associated with the linear sequence or other grouping 201 of image frames 200, the internal structural data 11 for the internal structure of the virtual object 10 can be based upon the virtual object 10 as set forth in the selected (or hero) image frame 210.

If the virtual object 10 comprises a bipedal virtual character 10A, the 3D data file can include standard biped skeletal tracking data associated with the bipedal virtual character 10A. The biped skeletal tracking data can be overlapped and/or compared with the selected image frame 210 to provide a sorted data set version that spatially coincides with the raw volumetric input data. One or more differences between the raw volumetric solution and the Keyframe smoother solution are stored to create a set of consistencies and/or differences (or inconsistencies) in a data consistency file. In selected embodiments, the Keyframe smoother solution can comprise a conventional Keyframe smoother solution.

FIG. 6D shows an exemplary representation of the bone structure for the bipedal virtual character 10A as shown in the selected (or hero) image frame 210 can be created from the 3D data file. In selected embodiments, the representation of the bone structure for the bipedal virtual character 10A can be created via a 3D video processing tool such as Captury Studio Ultimate, without limitation. The 3D video processing tool can generate a one-to-one skeleton match for the bone structure of the bipedal virtual character 10A to create original volumetric video assets. In other words, the 3D video processing tool can create a skeleton or other internal structure for the bipedal virtual character 10A with a complete bone structure that corresponds with the volumetric video asset.

The created skeleton for the bipedal virtual character 10A advantageously can match the received volumetric input data for the bipedal virtual character 10A. In selected embodiments, the created skeleton can provide unsorted character data for the bipedal virtual character 10A and a velocity grid per image frame 200 of the linear sequence, the selected image frame 210 or other grouping 201 of image frames 200 based upon the consistency and/or inconsistency of the created skeleton for the bipedal virtual character 10A as illustrated in FIG. 6E. The consistency and/or inconsistency of the created skeleton for the bipedal virtual character 10A advantageously can enable the virtual object asset generation method 100 to transfer a consistent velocity to the volumetric video data.

Returning again to FIG. 6A, the virtual object asset generation method 100, at 119, can generate the sparse volume data set 25 (shown in FIG. 4D) by combining the created sparse volume data file with skeleton structural data 435 (shown in FIG. 8) associated with the created skeleton for the bipedal virtual character 10A in the manner set forth in more detail herein, at 156, with reference to FIG. 4A. The sparse database volume file, for example, can be combined with the skeleton structural data 435 associated with the created skeleton for the bipedal virtual character 10A as set forth in the selected image frame 210 to generate the sparse volume data set 25. In selected embodiments, the sparse volume data set 25 can comprise a sparse VDB volume data set in the VDB format.

In selected embodiments, the virtual object asset generation method 100 can generate an estimate of a pose associated with the virtual character. The virtual object asset generation method 100, for instance, can utilize the virtual camera systems 65 (shown in FIG. 6B) in combination with the input volumetric asset to estimate the pose associated with the virtual character. In a non-limiting example, the virtual object asset generation method 100 can define and calibrate a predetermined number, such as twelve, of virtual camera systems 65 and the calibrated virtual camera systems 65 with the input volumetric video asset. The output from the virtual camera systems 65 can be filtered by both volume and color by utilizing a focal distance and camera calibration tracking to create the pose estimation for the virtual character. In selected embodiments, the output from the virtual camera system 65 can correspond with, or otherwise related to, an output of an underlying physical camera system 60 (shown in FIGS. 2B-C) and/or can be independent from the output of the physical camera system 60.

The virtual object asset generation method 100 thereby can be based on color data linked into UV texture coordinates of input 2D data. The UV texture coordinates, as set forth herein, can comprise a 3D modelling process of projecting a 2D image onto a selected surface of a 3D model for texture mapping. The letters U and V can denote axes of a 2D texture in contrast to the letters X, Y and Z, which are used herein to denote axes of a 3D object in model space; whereas, the letter W is used in calculating quaternion rotations, which is a common operation in computer graphics.

Continuing with the above example, the color data can be linked to the texture data 414 (shown in FIG. 8) as coordinated with the linear sequence or other grouping 201 of image frames 200. The virtual object asset generation method 100 thereby can support markerless motion capture with finger solve, which is a more granular and accurate manner for estimating character poses. The consistent calculated velocity plus the volume that the virtual character occupies can provide trajectory information for a created uniform mesh 13 for the bipedal virtual character 10A as illustrated in FIG. 6F. The created uniform mesh 13, as discussed herein, may travel from the first image frame 200A (shown in FIG. 7) to the second image frame 200B (shown in FIG. 7) within the linear sequence or other grouping 201 of image frames 200 associated with the created video asset.

In selected embodiments, the virtual object asset generation method 100 optionally can include rigging the created uniform mesh 13 over the skeleton or other internal structure of the bipedal virtual character 10A. The created uniform mesh 13 can be rigged over the skeleton or other internal structure of the bipedal virtual character 10A in any suitable manner. For example, the created uniform mesh 13 can be rigged over the skeleton or other internal structure of the bipedal virtual character 10A in 3D animation via biped skeletal rig deformation by proximity weighting. Additionally and/or alternatively, the virtual object asset generation method 100 advantageously can utilize the complete bone structure and/or other internal structure of the bipedal virtual character 10A to provide a velocity to the high detail changing mesh to permit video tracking to occur in an image frame 200 by image frames 200 manner.

To help ensure that the high detail changing mesh can accurately track with the motion of the bipedal virtual character 10A, the velocity vector can provide a direction in which the deformation of the image frames 200 should occur. Providing the direction of deformation can limit the space the mesh can occupy due to calculated restraints on how the internal structure of the actual bipedal character or physical object 50 (shown in FIG. 2B) would be capable of moving. These calculated restraints likewise can limit the space the character mesh can occupy due to the volume voxel grid and the constraints on movement of the bipedal virtual character 10A. Defining the volume voxel grid can define the bounding region occupied throughout a movement sequence compared to a current character volume location in time within the movement sequence. The virtual object asset generation method 100 advantageously can perform the calculations to limit and/or normalize the volumetric motion data within a range of motion of the bipedal virtual character 10A.

To create a reference beginning point for the virtual camera systems 65 (shown in FIG. 6B), the virtual object asset generation method 100 can choose the selected (or hero) image frame 210 (shown in FIG. 6C) from among the linear sequence or other grouping 201 of image frames 200 (shown in FIG. 6C). The selected (or hero) image frame 210 and a position of the bipedal virtual character 10A or other virtual object 10 within the selected image frame 210 can be selected to expose each of the virtual camera systems 65 to that selected image frame 210 and can determine relative positioning for the virtual camera systems 65 as a reference from which all future computations may be created.

In the manner discussed in more detail above with reference to FIGS. 4A-D, an exemplary selected (or hero) image frame 210 can include a “T frame.” The “T frame” can comprise an image frame 200 in which the bipedal virtual character 10A is positioned upright with upper limbs extended horizontally at a ninety degree angle (or perpendicularly) relative to a vertical main body of the bipedal virtual character 10A. The virtual camera systems 65 advantageously can utilize the selected (or hero) image frame 210 to fit the 3D data file and skeletal bone or other internal structure data for each of the positioned virtual camera systems 65. This fit can help improve the two-dimensional UV data provided by the virtual camera systems 65 to a higher resolution and/or quality than is found in the initial 2D image data included in the set of (volumetric) input data received by the virtual object asset generation method 100.

In selected embodiments, the virtual object asset generation method 100 advantageously can utilize Sequential Vertex Interpolation (or SVI). Sequential Vertex Interpolation is a lossless process that reduces a total file size of a data set by identifying unique key frames and storing surface normal and UV information to transfer to subsequent similar frames point-only data sets. These point-only data sets are referred to as template frames.

The SVI technique can take advantage of an efficiency of a point cloud with the density of a 3D mesh. In selected embodiments, a 3D mesh can comprise an interconnected series of points, or vertices, which form surface polygons. The 3D mesh can include a web of connections where each point is connected to two nearest points. A surface formed by the series of surface polygons can be defined by surface normal for each face formed by connected points.

Each point on a 3D polygonal mesh object has a unique point number. In a sequence of 3D polygonal meshes, a topology of the object can be similar, and the corresponding point numbers can be similar to the previous frame. The topology, for example, can include one or more rules of a 3D polygon mesh as concerned with the properties of a geometric object that are preserved under continuous deformations, such as stretching, twisting, crumpling, and bending; that is, without closing holes, opening holes, tearing, gluing, or passing through itself. This consistency can allow for attributes to be transferred between objects. The transference advantageously can provide an opportunity to set one object as a key object. The key object can store data to be transferred to the subsequent template frames.

When a next frame in a frame sequence is unique, which can be defined as having a topology that is not similar to a previous frame, the unique frame can be identified and labeled as a next key frame. In an embodiment, the key frame can store the surface normal vector data. This set of normal vector data can identify an outwardly facing direction of the 3D mesh and how light interacts with the surface polygon for the object(s) captured in the key frames. The surface polygon, for example, can be a triangular or quadrangular primitive vector-point base object.

The primitive can include one or more primitive attributes. The primitive attributes can include, but are not limited to, points, polygons and/or volume data that can be stored within a 3D object and/or a 3D object sequence. These primitive attribute values can be referenced in process calculations when executed in physics, render or content manipulation. In selected embodiments, all data associated with the primitive can fall into these categories with the exception of detail attributes, which often are strings referring to files or group names.

Surface mesh point normal positions can be oriented to point outward from the object. In selected embodiments, light can bounce in a direction of a ray trace. In a non-limiting example, this is generally defined as the direction where the angle of incidence equals the angle of reflectance when ray tracing is performed on the object.

Additionally and/or alternatively, the key frame can store UV data for objects in the frame. The UV data can include a 2D float vector that identifies the texture mapping for the object(s) in the frame. The template frames have the same UV and point normal states as the key frames. These same states can allow the stored data to reach each point based upon the correlation of the unique point number for each point in the object(s) within the frame.

Temporally-coherent uniform volumetric video can provide a texture that runs smoothly and that can take advantage of streaming standards, such as the MP4 video compression standard promulgated by the Moving Picture Experts Group. Temporal coherence can comprise a partially sorted mesh topology and paired UV coordinates that can be created from tracking a motion of an object to subsequent similar shape and volume. In selected embodiments, the temporal coherence can be created from a Hausdorff Distance. Limited temporal coherence, for example, can be found in export processes of volumetric video proprietary systems.

In selected embodiments, the virtual object asset generation method 100 can utilize temporal textures to consistently apply standard video compression and persistent, ongoing data stream volumetric video to provide for a smoother, consistent video interaction between an object and an environment surrounding the object. With this consistency, one or more point similarities can be trailed across the frame range to illustrate the motion path of the elements of the objects within the video environment.

The virtual object asset generation method 100, for example, can invert the backward distance velocity of a portion or element of an object to predict deformation. The predicted deformation parameter can be stored in the point data, removing the excess surface mesh, UVs, and normal data stored in each image frame. The resultant file size can be up to twenty times smaller than the total file size of the original frame sequence.

In selected embodiments, the virtual object asset generation method 100 can generate sub-step accuracy. The sub-step accuracy can be captured, for example, via generation of subframe data that can yield more accurate results by providing a much more granular image frame sequencing for generated virtual object assets. The virtual object asset generation method 100 optionally can solve for subframe solutions through the use of the subframe data. Simulations can use linear values built into a calculation of output frame sequencing. By identifying a difference between two key frame values of the mesh data 412, the creation of subframes can performed via interpolation of where the mesh is in that space utilizing any exactly decimated point in time.

The decimation of time can include a number of decimal places into which the time points are divided to achieve the accuracy of the subframe desired. In a non-limiting example, the subframe process receive an input video (not shown) running at sixty frames per second and provide an output subframe video (not shown) running at one hundred and fifty frames per second using a decimation value of two and one-half. The subframe process can occur during dynamic simulation render within a processing system (or circuit) (not shown) for performing the virtual object asset generation method 100.

The virtual object asset generation method 100 thereby can support streaming video solves that are not limited to a nearest point in a wire mesh, but instead can be reminiscent of true spatial deformation that moves through a smooth change in special positioning for each image frame and/or can minimize a step-wise movement based on changes in position from frame to frame of the video. Advantageously, the sub-step accuracy can comprise a more accurate solution because velocity tracking can be applied during calculations. In a non-limiting example, the virtual object asset generation method 100 can be configured to effectively track portions of the hands and/or face of the virtual object 10 not only from frame to frame, but also between frames.

The calculation of sub-frame positioning thereby can smooth movement of the virtual object 10 and provide smoother transitions in position of a body of the virtual object 10 through interpolation of body positioning of the virtual object 10 between frames. The resulting output subframe video can individually track all body parts of the virtual object 10 accurately to the whole body of the virtual object 10. Additionally and/or alternatively, the higher-frequency sub-frame tracking can allow smoother interaction with the computer-generated effects, cloth, liquids, or other aspects of virtual object interaction within the frame, especially with higher speeds and/or higher frame recording rates. The resulting output subframe video can comprise an equivalent of reducing motion blend for volumetric video.

In selected embodiments, the virtual object asset generation method 100 can utilize a push volume that deforms the body of the virtual object 10 as the body interacts with real world physics data within one or more virtual environments. Additional layered effects optionally can be applied over the created virtual object 10.

An exemplary process workflow 400 is shown in FIG. 8 for illustrating operation of the virtual object asset generation method 100. The process workflow 400 is illustrated as receiving input data, at 410. In the manner discussed in more detail above with reference to FIG. 1A, the input data 410 can include, but is not limited to, three-dimensional (or 3D) mesh data 412, such as three-dimensional triangular mesh data 412A and/or texture data 414 associated with a virtual object 10 (shown in FIG. 1A).

At 420, one or more camera systems 60 (shown in FIGS. 2B-C), such as virtual camera systems 65 (shown in FIG. 6B) and/or other computer-generated camera systems (or circuits), can be applied to the received input data 410. The camera systems 60 can be applied to the input data 410 in any suitable manner. As shown in FIG. 8, for example, a three-dimensional (or 3D) data file 425 can be created by combining respective location information for the camera systems 60 with two-dimensional image data for the virtual object 10 in the manner discussed in more detail herein with reference to FIG. 6A, at 116. In selected embodiments, the two-dimensional image data of the virtual object 10 can be virtually captured by, or otherwise associated with, the virtual camera systems 65.

Skeleton structural data 435 for the virtual object 10 can be generated, at 430. In selected embodiments, the triangular mesh data 412A and the 3D data file 425 can be combined to generate the skeleton structural data 435. The skeleton structural data 435 can be generated, at 430, in any suitable matter, including in the manner set forth above, at 118, with reference to FIG. 6A.

At 440, three-dimensional quadrangular mesh data can be created for the virtual object 10. The quadrangular mesh data can be created in any suitable manner, such as the manner described in more detail above, at 162, with reference to FIG. 5, without limitation. As shown in FIG. 8, for example, the process workflow 400 can include combining the 3D data file 425 and the skeleton structural data 435. A selected (or hero) image frame 210 can be selected, at 442, from the 3D data file 425 and/or the skeleton structural data 435. The selected image frame 210 can be selected, at 442, in any suitable manner. An exemplary manner for selecting the selected image frame 210 is set forth with reference to FIG. 5, at 162.

The quadrangular mesh data can be created, at 444, based upon the selected image frame 210. As described with reference to FIG. 5, at 162, for instance, the quadrangular mesh data based upon the selected image frame 210 can comprise a quadrangular rest mesh for the outer surface 12 (shown in FIG. 1A) of the virtual object 10. The quadrangular mesh data advantageously can comprise improved UV data as shown in FIG. 8.

The process workflow 400 can include preparations, at 450, for generating an object file for the virtual object 10; whereas, the object file can be generated at 460. At 452, for example, the triangular mesh data 412A can be compiled. A bounding box 20 for establishing the boundaries of movement for the virtual object 10 can be defined, at 462. An exemplary manner for defining the bounding box 20 is described herein with reference to FIGS. 4A-D. Optionally, data associated with individual image frames 200 associated with the triangular mesh data 412A can be compiled, at 454, and/or the skeleton structural data 435 can be compiled, at 456.

As illustrated in FIG. 8, the process workflow 400 can include, at 464, creating a sparse volume data file for a volume of the virtual object 10 associated with the selected image frame 210. The sparse volume data file can be created in any suitable manner. In selected embodiments, the sparse volume data file can be created in the manner discussed in more detail herein with regard to FIG. 4A, at 154. Additionally and/or alternatively, a (final) sparse volume data set 25 (shown in FIG. 4A) can be generated by combining the created sparse volume data file with the skeleton structural data 435 for the virtual object 10 in the manner discussed in more detail above with reference to FIG. 4A. at 156.

The process workflow 400 is shown as defining push volume data, at 466. The push volume data can be defined, at 466, in any suitable, manner. An exemplary suitable manner is shown and described, at 158, in FIG. 4A. In selected embodiments, the push volume data can be defined based upon the defined bounding box 20 and the generated sparse volume data. In other word, the sparse volume data set 25 can be subtracted from the defined bounding box 20 to create a negative space 30 representing an object volume 32 of the virtual object 10 within the bounding box 20.

As illustrated in FIG. 8, the process workflow 400 can include generating an object file (or an object data file) for the virtual object 10, at 470. The object data file can be generated in any suitable manner and can be provided in an ABC file format, a FBX file format and/or a GLB file format. In the manner discussed, at 160, as shown in FIG. 3, the object data file can be generated by compiling the created quadrangular mesh data and the defined push volume data of the virtual object 10.

Texture map data can be created, at 480. The texture map data can be created in the manner set forth in more detail with reference the creation of the texture map data, at 170, of FIG. 3. As shown in FIG. 8, for example, the texture map data for the virtual object 10 can be created by combining the generated object data file with the texture data 414 for the virtual object 10. The generated object data file and the created texture map data can be provided as a complete virtual object asset. The complete virtual object asset can be provided in the manner discussed in more detail with reference to FIG. 8, at 180.

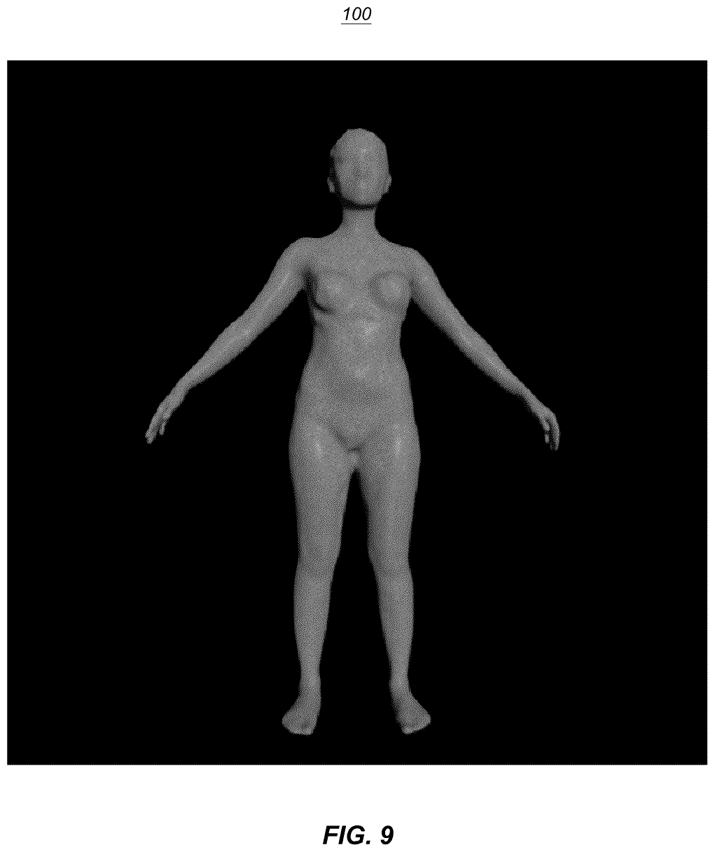

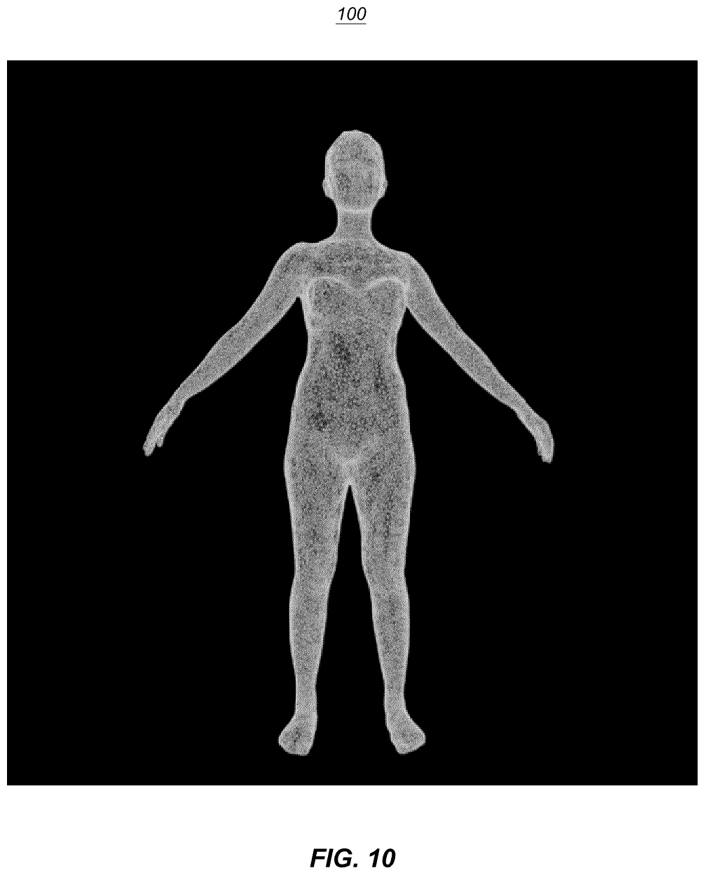

Turning to FIG. 9, an exemplary embodiment of a triangular polygonal surface mesh sequence is shown. The triangular polygonal surface mesh sequence advantageously can comprise the three-dimensional triangular mesh data 412A that can be received by the virtual object asset generation method 100 in the manner discussed in more detail above with reference to FIGS. 1A and 8. FIG. 10 shows an exemplary wireframe mesh sequence that can be received by the virtual object asset generation method 100. The wireframe mesh sequence of FIG. 10 can be associated with the triangular mesh data 412A of FIG. 9. In selected embodiments, the wireframe mesh sequence can comprise the wire-frame model 16 as shown and described with reference to FIG. 1B.

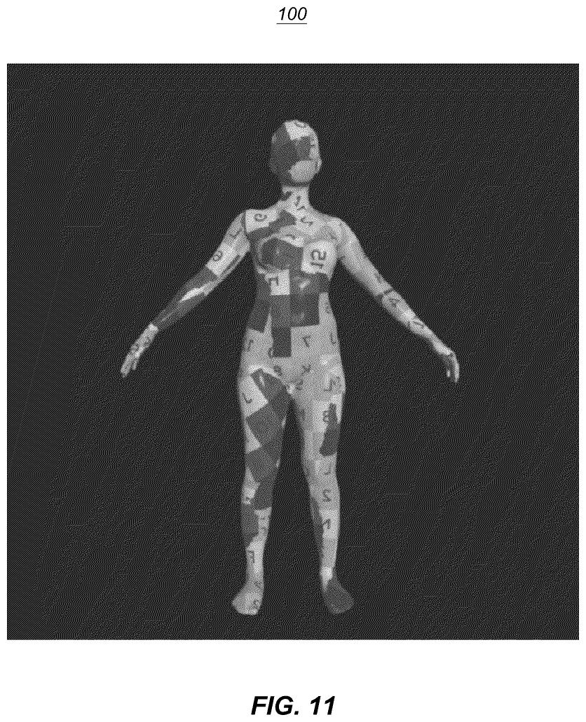

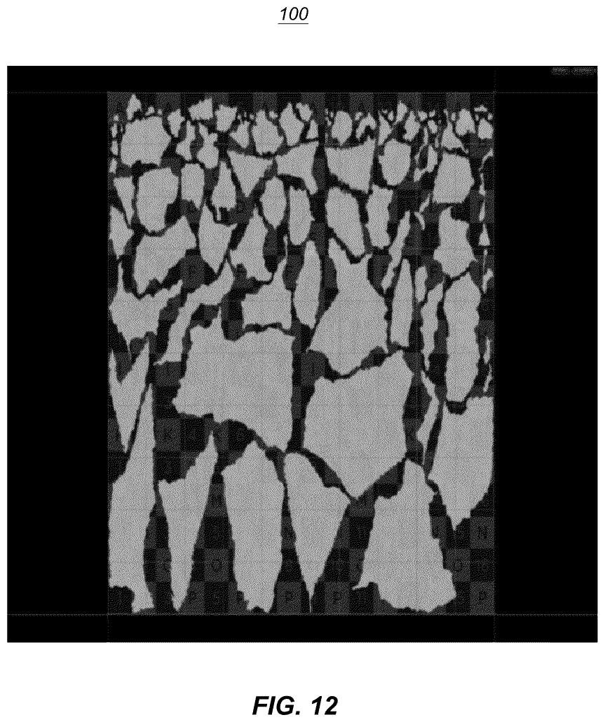

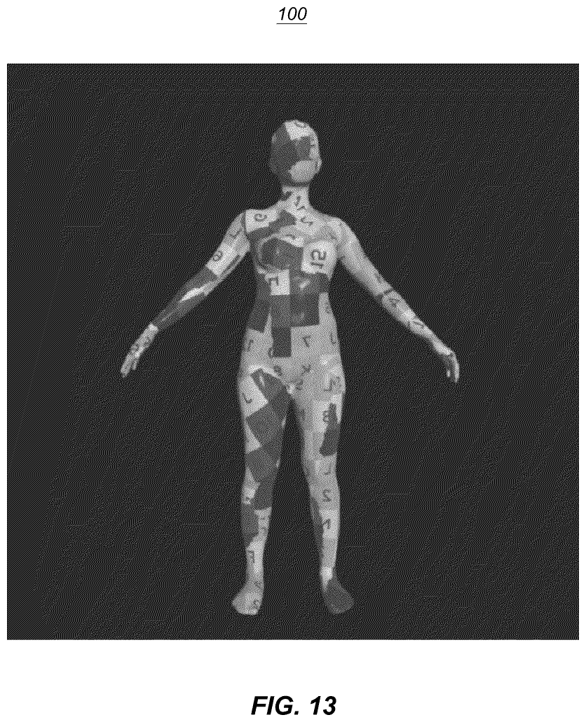

In the manner discussed in more detail above with reference to FIG. 1A, the mesh data 412 associated with the virtual object 10 can be based upon a three-dimensional (or 3D) polygonal surface mesh formed on the outer surface 12 of the virtual object 10. FIG. 11 shows an exemplary input polygonal surface mesh sequence with paired UV coordinate vertex attributes for the outer surface 12 of the virtual object 10 of FIG. 9. The UV data can include a 2D float vector that identifies the texture mapping for the virtual object 10 in the frame in the manner set forth herein. FIG. 12 shows an exemplary embodiment of UV coordinates image of a set of 2D float vector vertex attributes for the triangular polygonal surface mesh sequence of FIG. 9. Turning to FIG. 13, an input polygonal surface mesh animated sequence with mapped UV attributes is shown. As frames of the video sequence cycle, the surface mesh topology and UV coordinates can change.

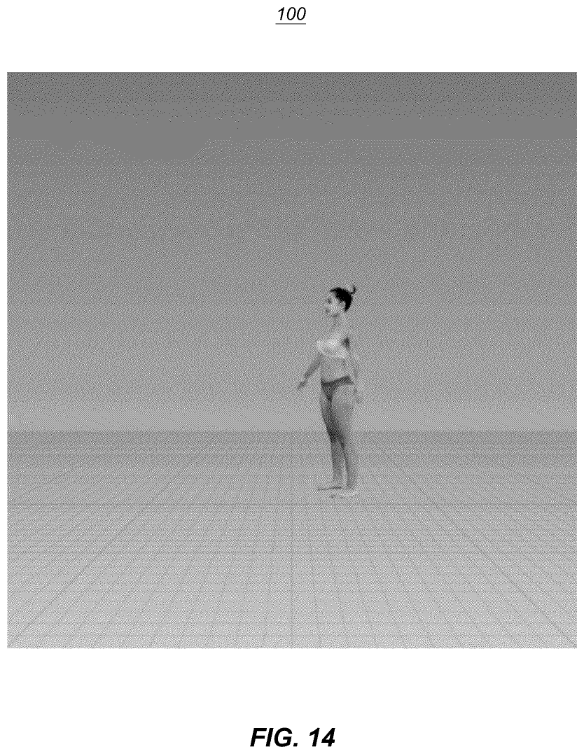

FIG. 14 illustrates an exemplary calibration data set for the virtual camera system 65 (shown in FIG. 6B). The calibration data set advantageously can be paired with the volumetric mesh and texture sequence of FIG. 9 and can be utilized as input data for the solver process. The calibration data set shown in FIG. 14 can present the same image frame 200 as the image frame 200 associated with the volumetric mesh and texture sequence illustrated in FIG. 9.

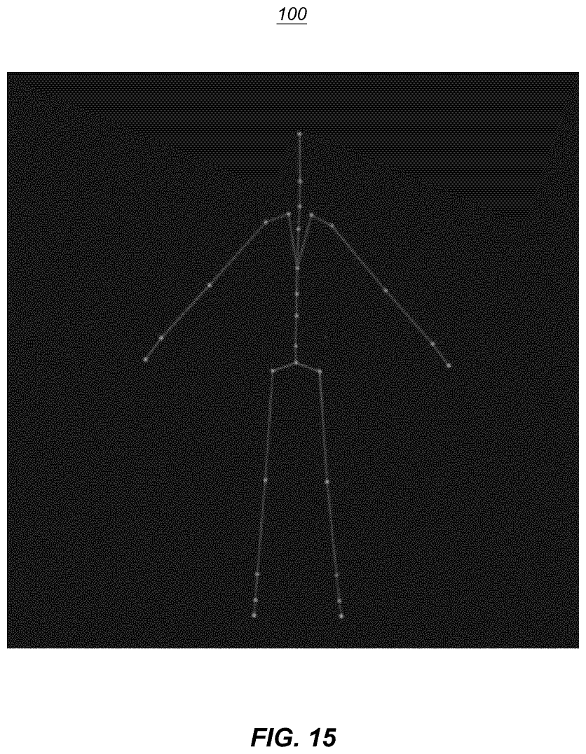

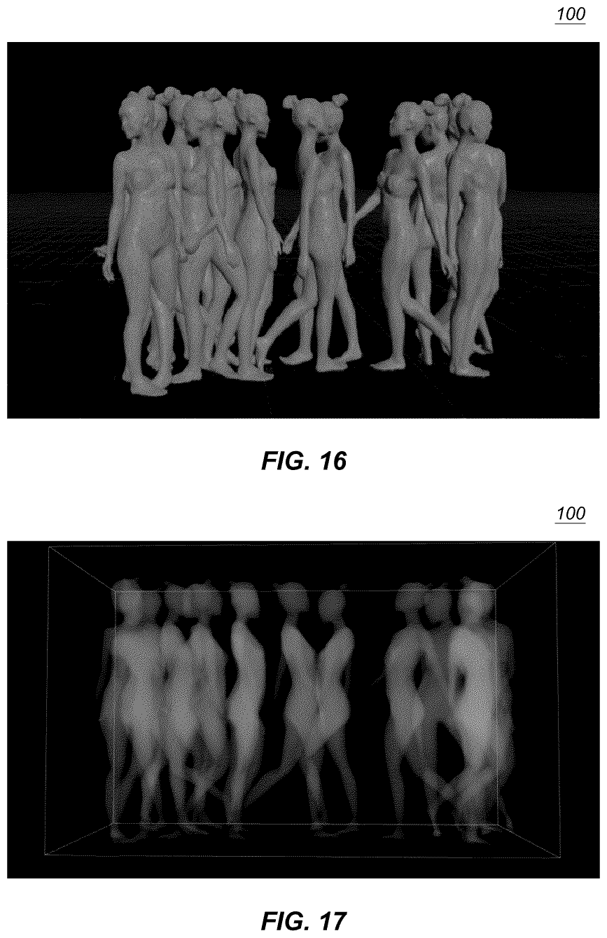

FIG. 15 illustrates an exemplary biped skeleton that can be generated by the virtual object asset generation method 100. The biped skeleton advantageously can provide orientation and velocity vector inputs to assist with a uniform linear solve. As shown in FIG. 16, a plurality of frame time values in a geometry sequence can be merged. In selected embodiments, all frame time values in the geometry sequence can be merged together. The objects preferably are merged to fill a maximum volume region in a defined worldspace.

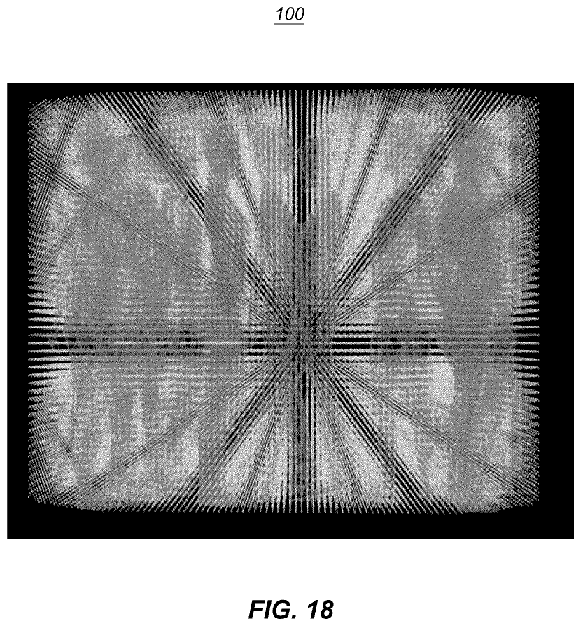

A sample of a volume from the merged frame time values of FIG. 16 are shown in FIG. 17. Turning to FIG. 17, the sample can comprise an OpenVDB sample of the volume from a merged object set that and can provide a bounding region for the volume. This example presents the calculation for all analyses of the figures or objects within the (red) box object depicted. A voxel grid for showing occupied space of the merged frame time values is shown in FIG. 18. As illustrated in FIG. 18, the sparse volume regions can be subtracted over time per frame. The sparse volume regions are known as a volume Boolean and/or negated volume voxels.

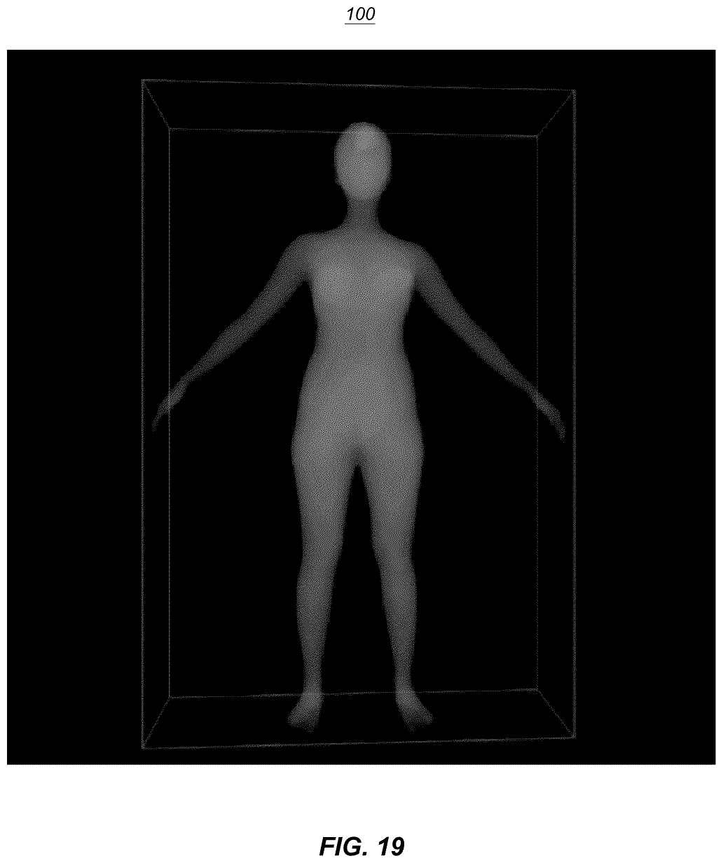

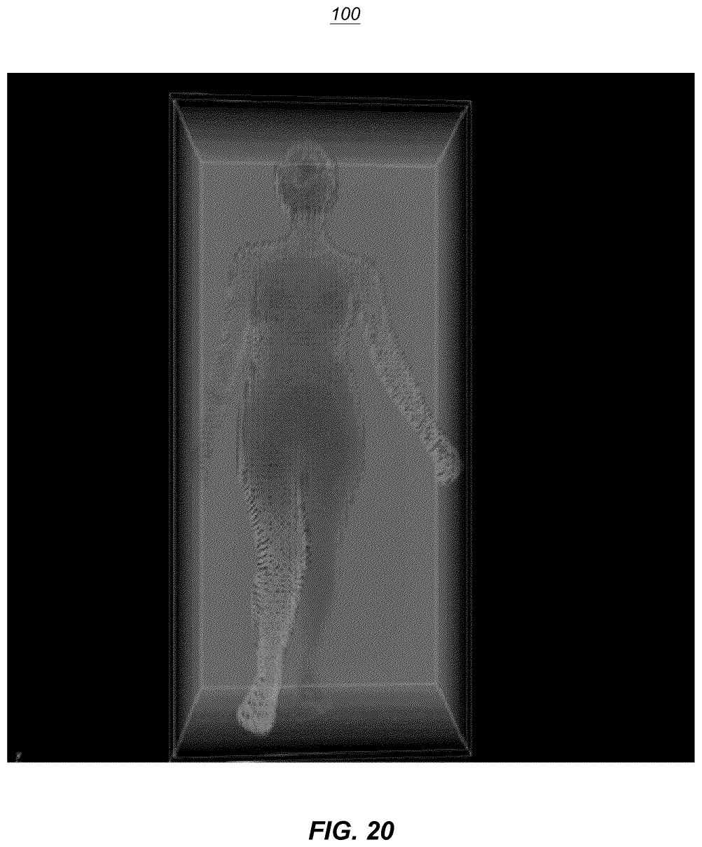

An exemplary embodiment of a single frame volume cloud density attribute for the triangular polygonal surface mesh sequence is shown in FIG. 19. Turning to FIG. 19, the single frame volume cloud density attribute is shown as comprising a single frame volume VSB cloud density attribute. FIG. 20 illustrates a single frame volume cloud velocity attribute in a dense volume for the triangular polygonal surface mesh sequence. The single frame volume cloud velocity attribute is illustrated in FIG. 20 as including a single frame volume VSB cloud Velocity attribute in a dense volume.

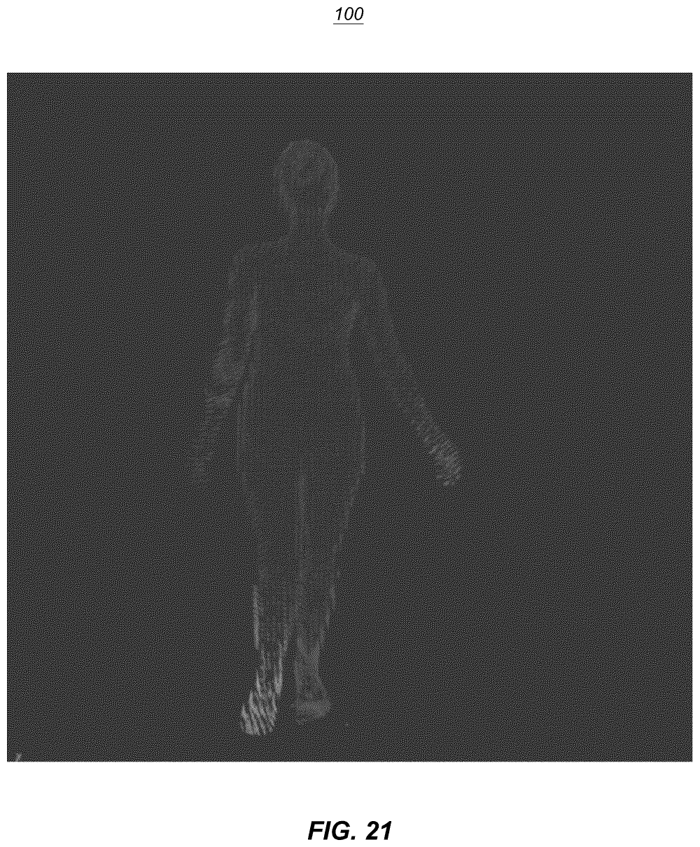

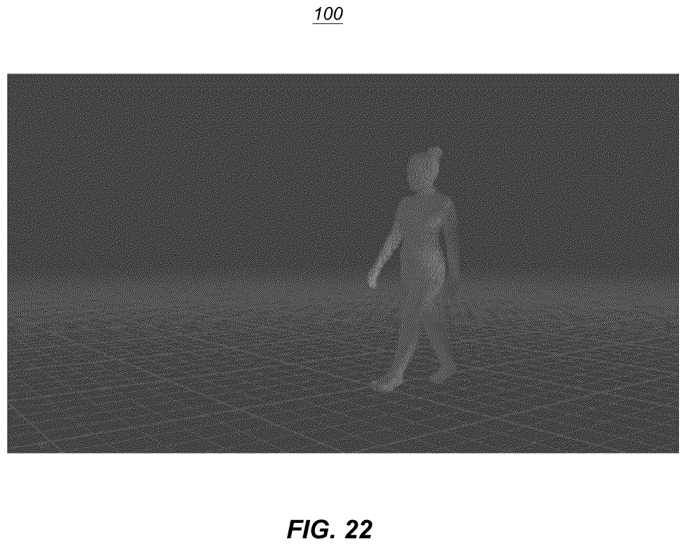

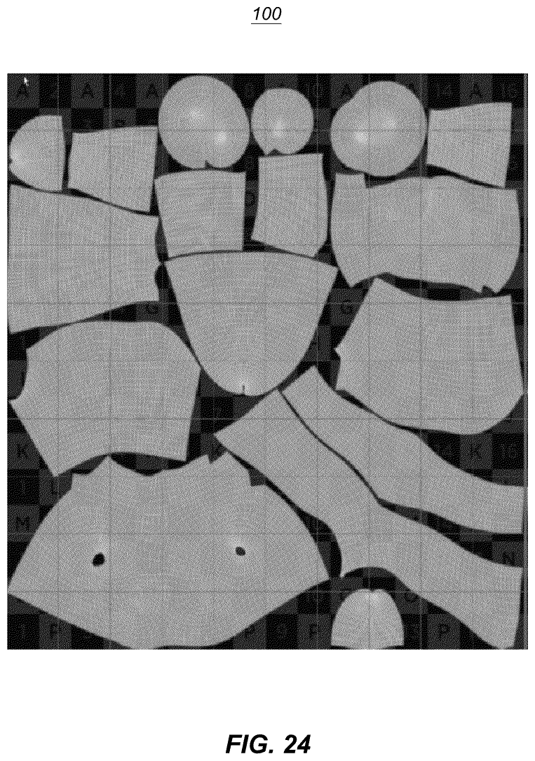

Turning to FIG. 21, a single frame voxel velocity sample for the triangular polygonal surface mesh sequence is shown. The single frame voxel velocity sample can be prepared to deform a single frame quadrangular mesh recalculated and reapplied topology of the original source mesh sequence. FIG. 22 shows a voxel velocity sequence for the calibration data set. Stated somewhat differently, the voxel velocity sequence can be configured to show one or more changes in velocity direction. In selected embodiments, high frequency noise, also known as jitter, can be filtered out of the deformation process to avoid anomalies. The filtering can be performed in any suitable manner, including, for example, by blending attributes over a series of ten frames per sixty frames per second sequence of frames. FIG. 23 shows an exemplary quadrangular mesh generated for the triangular polygonal surface mesh sequence. In selected embodiments, the quadrangular mesh can comprise an automated quadrangular mesh. The quadrangular mesh, for example, can be generated with smart UVs based upon customized procedural process workflows built for this process. The quadrangular mesh can comprise the input receiver frame for the uniform solve process. Turning to FIG. 24, an exemplary smart UV layout is shown. The smart UV layout of FIG. 24 can comprise a smart UV layout of a created uniform set with reference to the mesh presented in FIG. 23.

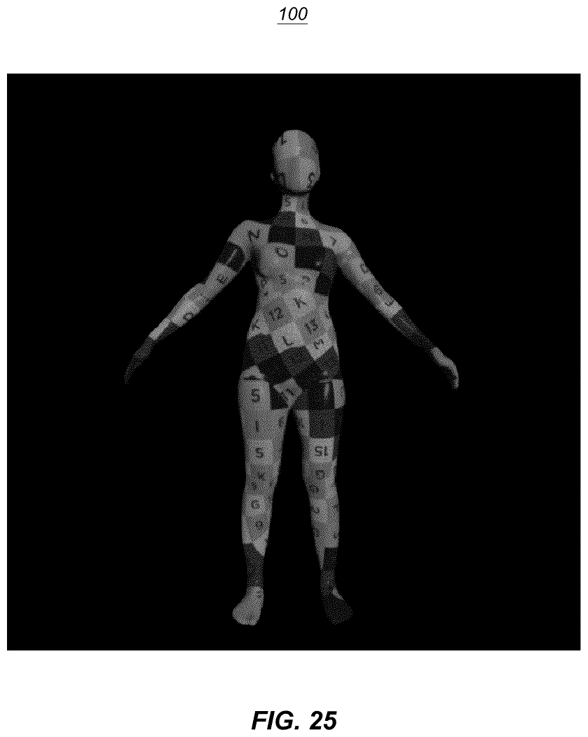

Turning now to FIG. 25, the voxel velocity grid and the negated volume region are shown as being used to solve the quadrangular mesh in a linear solver. A fidelity of the surface tracking can be based upon a resolution of the volume grid. In this example, a lower point value can represent a higher fidelity and exponentially more computational solve than a higher point value.

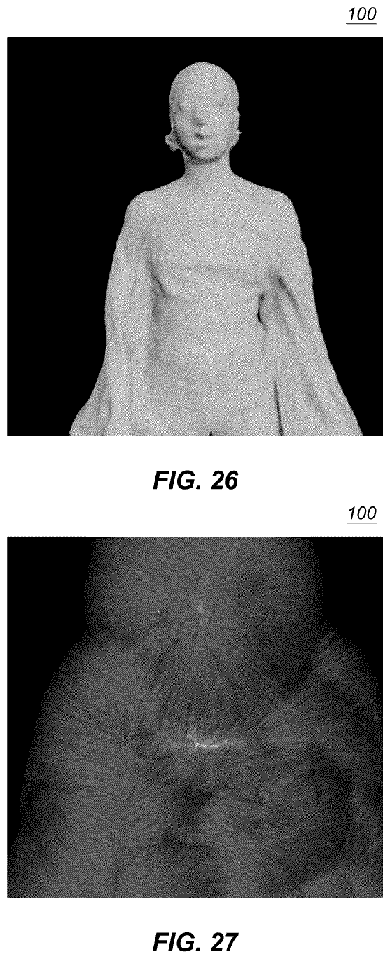

FIG. 26 illustrates a 3D mesh based upon the quadrangular mesh of FIG. 25. The 3D mesh can present an interconnected series of points (or vertices) that can form one or more surface polygons. In selected embodiments, the 3D mesh can comprise a web of connections of a point to each of the nearest two points. The surface can be defined by surface normal for each face of connected points.

FIG. 27 shows an exemplary embodiment of a surface of mesh point normal pointing outward from an object.

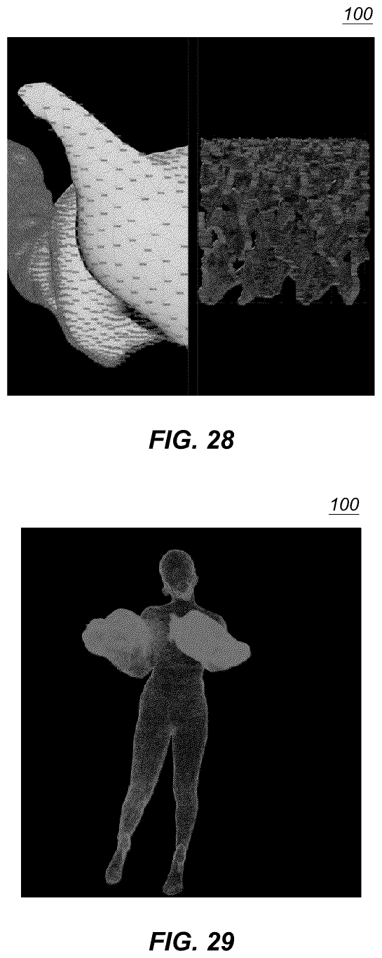

Turning now to FIG. 28, an exemplary set of unique point numbers corresponding to a UV layout is shown. FIG. 28, for example, shows a 3D mesh with point number identifier visualization and a view of the corresponding UV set providing the unique point numbers and corresponding data attributes. FIG. 29, this figure illustrates a backward distance velocity being inverted for predicting a deformation. Stated somewhat differently, the virtual object asset generation method 100 can include inverting the backward distance velocity to predict deformation.

In selected embodiments, one or more of the features disclosed herein can be provided as a computer program product being encoded on one or more non-transitory machine-readable storage media. As used herein, a phrase in the form of at least one of A, B, C and D herein is to be construed as meaning one or more of A, one or more of B, one or more of C and/or one or more of D. Likewise, a phrase in the form of A, B, C or D as used herein is to be construed as meaning A or B or C or D. For example, a phrase in the form of A, B, C or a combination thereof is to be construed as meaning A or B or C or any combination of A, B and/or C.

The terms “a” or “an”, as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

Reference throughout this document to “one embodiment”, “certain embodiments”, “an embodiment” or similar terms means that a particular feature, structure, or characteristic described in connection with the embodiment is included in at least one embodiment disclosed herein. Thus, the appearances of such phrases or in various places throughout this specification are not necessarily all referring to the same embodiment. Furthermore, the particular features, structures, or characteristics may be combined in any suitable manner in one or more embodiments without limitation.

The disclosed embodiments are susceptible to various modifications and alternative forms, and specific examples thereof have been shown by way of example in the drawings and are herein described in detail. It should be understood, however, that the disclosed embodiments are not to be limited to the particular forms or methods disclosed, but to the contrary, the disclosed embodiments are to cover all modifications, equivalents, and alternatives.

What is claimed is:

1. A computer-implemented method for virtual object asset generation, comprising:
generating one or more boundaries of movement for a virtual object asset based upon mesh data associated with a virtual object via a processing circuit;
generating an object file for the virtual object by compiling the mesh data and generated boundaries with at least one velocity vector associated with the virtual object via the processing circuit; and
creating texture map data for the virtual object by combining the generated object file with texture data associated with the virtual object via the processing circuit.

2. The method of claim 1, further comprising providing the generated object file and the created texture map data as a complete virtual object asset.

3. The method of claim 1, wherein the virtual object comprises a bipedal virtual character.

4. The method of claim 1, wherein said generating one or more boundaries of movement includes:
defining a bounding box for the virtual object based upon the mesh data associated with the virtual object;
creating a sparse volume data file for a volume of the virtual object associated with a selected image frame;
generating a sparse volume data set by combining the created sparse volume data file with internal structural data associated with the virtual object; and
defining push volume data based upon the defined bounding box and the generated sparse volume data set.

5. The method of claim 4, wherein said defining the push volume data comprises defining push volume data by subtracting a sparse volume associated with the generated sparse volume data set from a bounding box volume associated with the defined bounding box.

6. The method of claim 4, further comprising generating the internal structure data for the virtual object.

7. The method of claim 6, further comprising receiving a plurality of image frames that includes the mesh data associated with the virtual object,
wherein said generating the internal structure data for the virtual object includes generating the internal structure data for the virtual object being associated with a selected image frame among the plurality of image frames, and
wherein said generated the sparse volume data set includes generated the sparse volume data set by combining the created sparse volume data file with the generated internal structure data for the virtual object.

8. The method of claim 6, further comprising:
receiving a plurality of image frames that includes the mesh data associated with the virtual object;
identifying respective location information for each of a plurality of camera circuits from which the plurality of image frames was captured based upon the mesh data;
disposing a plurality of virtual cameras around the virtual object based upon the identified location information; and
creating a three-dimensional data file by combining the identified location information with two-dimensional image data of the virtual object, the two-dimensional image data being associated with the virtual cameras,
wherein said generating the internal structure data for the virtual object includes generating the internal structure data for the virtual object being associated with a selected image frame among the plurality of image frames based upon the created three-dimensional data file, and
wherein said generated the sparse volume data set includes generated the sparse volume data set by combining the created sparse volume data file with the generated internal structure data for the virtual object.

9. The method of claim 8, wherein said receiving the plurality of image frames comprises receiving the plurality of image frames that includes three-dimensional triangular mesh data associated with the virtual object.

10. The method of claim 8, wherein said receiving the plurality of image frames includes receiving the plurality of image frames that includes the texture data associated with the virtual object.

11. The method of claim 1, wherein said generating the one or more boundaries of movement for the virtual object asset comprises generating the one or more boundaries of movement for the virtual object asset based upon triangular mesh data associated with the virtual object.

12. The method of claim 11, further comprising receiving a plurality of image frames that includes the triangular mesh data associated with the virtual object.

13. The method of claim 12, wherein said receiving the plurality of image frames comprises a linear sequence of image frames.

14. The method of claim 12, further comprising:
creating a quadrangular mesh data associated with the virtual object associated with a selected image frame among the plurality of image frames;
generating an object file for the virtual object by compiling the created quadrangular mesh data and generated boundaries with one or more velocity vectors associated with the virtual object; and
creating texture map data for the virtual object by combining the generated object file with texture data for the virtual object.

15. The method of claim 14, wherein said creating the quadrangular mesh data includes creating the quadrangular mesh data associated with the virtual object associated with a T frame among the plurality of image frames.

16. A computer program product for virtual object asset generation, the computer program product being encoded on one or more non-transitory machine-readable storage media and comprising:
instruction generating one or more boundaries of movement for a virtual object asset based upon mesh data associated with a virtual object;
instruction for generating an object file for the virtual object by compiling the mesh data and generated boundaries with at least one velocity vector associated with the virtual object; and
instruction for creating texture map data for the virtual object by combining the generated object file with texture data associated with the virtual object.

17. A system for virtual object asset generation, comprising:
at least one processing circuit being configured for generating one or more boundaries of movement for a virtual object asset based upon mesh data associated with a virtual object, generating an object file for the virtual object by compiling the mesh data and generated boundaries with at least one velocity vector associated with the virtual object and creating texture map data for the virtual object by combining the generated object file with texture data associated with the virtual object.
